(19) United States
(12) Patent Application Publication
(10) Pub. No.: US 2006/0036874 A1
(43) Pub. Date: Feb. 16, 2006

(54) Data pattern verification in a gaming machine environment

(75) Inventors: Warner Cockerille, Sparks, NV (US); Jamal Benbrahim, Reno, NV (US); Dwayne Nelson, Las Vegas, NV (US)

Correspondence Address: BEYER WEAVER & THOMAS LLP, P.O. BOX 70250, OAKLAND, CA, 94612-0250, US

(73) Assignee: IGT

(21) Appl. No.: 11/221,314

(22) Filed: Sep. 6, 2005

Related U.S. Application Data
(63) Continuation-in-part of application No. 10/680,041, filed on Oct. 6, 2003.
Application No. 10/680,041 is a continuation of application No. 09/925,098, filed on Aug. 8, 2001, now Pat. No. 6,685,567.

(51) Int. Cl. G06F 12/14

(52) U.S. Cl. 713/187

(57) ABSTRACT

A technique is disclosed for detecting at least one anomaly associated gaming data, wherein the gaming data is associated with a first casino gaming machine. A first portion of gaming data is selected for analysis. According to a specific embodiment, the first portion of gaming data corresponds to a first data pattern. A first comparison pattern relating to the first data pattern is also selected. A comparison is then performed in which the first comparison pattern is compared with a first portion of the first data pattern. Based upon the results of the comparison, a determination may be made as to whether at least one anomaly is detected in association with the first data pattern.

### RELATED APPLICATION DATA

This application is a continuation-in-part of prior U.S. patent application Ser. No. 10/680,041 (Attorney Docket No. IGT1P052C1) entitled “Process Verification” by Cockerille et al., filed on Oct. 6, 2003, which is a continuation of U.S. Pat. No. 6,685,567, from which priority is claimed pursuant to the provisions of 35 U.S.C. Section 120. Each of these applications is incorporated herein by reference in its entirety and for all purposes.

### BACKGROUND OF THE INVENTION

This invention relates to gaming machines such as video gaming machines and video poker machines. More particularly, the present invention relates to techniques for implementing pattern comparisons of various types of electronic information associated with a gaming machine or gaming system in order to verify the authenticity of such information and/or to identify suspect or unauthorized portions of such information.

Typically, utilizing a master gaming controller, a gaming machine controls various combinations of devices that allow a player to play a game on the gaming machine and also encourage game play on the gaming machine. For example, a game played on a gaming machine usually requires a player to input money or indicia of credit into the gaming machine, indicate a wager amount, and initiate a game play. These steps require the gaming machine to control input devices, including bill validators and coin acceptors, to accept money into the gaming machine and recognize user inputs from devices, including touch screens and button pads, to determine the wager amount and initiate game play. After game play has been initiated, the gaming machine determines a game outcome, presents the game outcome to the player and may dispense an award of some type depending on the outcome of the game.

As technology in the gaming industry progresses, the traditional mechanically driven reel gaming machines are being replaced with electronic counterparts having CRT, LCD video displays or the like and gaming machines such as video gaming machines and video poker machines are becoming increasingly popular. Part of the reason for their increased popularity is the nearly endless variety of games that can be implemented on gaming machines utilizing advanced electronic technology. In some cases, newer gaming machines are utilizing computing architectures developed for personal computers. These video/electronic gaming advancements enable the operation of more complex games, which would not otherwise be possible on mechanical-driven gaming machines and allow the capabilities of the gaming machine to evolve with advances in the personal computing industry.

To implement the gaming features described above on a gaming machine using computing architectures utilized in the personal computer industry, a number of requirements unique to the gaming industry must be considered. One such requirement is the regulation of gaming software. Typically, within a geographic area allowing gaming, i.e. a gaming jurisdiction, a governing entity is chartered with regulating the games played in the gaming jurisdiction to insure fairness and to prevent cheating. Thus, in many gaming jurisdictions, there are stringent regulatory restrictions for gaming machines requiring a time consuming approval process of new gaming software and any software modifications to gaming software used on a gaming machine.

In the past, to implement the play of a game on a gaming machine, a monolithic software architecture has been used. In a monolithic software architecture, a single gaming software executable is developed. The single executable may be burnt onto an EPROM and then submitted to various gaming jurisdictions for approval. After the gaming software is approved, a unique signature can be determined for the gaming software stored on the EPROM using a method such as a CRC. Then, when a gaming machine is shipped to a local jurisdiction, the gaming software signature on the EPROM can be compared with an approved gaming software signature prior to installation of the EPROM on the gaming machine. The comparison process is used to ensure that approved gaming software has been installed on the gaming machine.

A disadvantage of a monolithic programming architecture is that a single executable that works for many different applications can be quite large. For instance, gaming rules may vary from jurisdiction to jurisdiction. Thus, either a single custom executable can be developed for each jurisdiction or one large executable with additional logic can be developed that is valid in many jurisdictions. The customization process may be time consuming and inefficient. For instance, upgrading the gaming software may require developing new executables for each jurisdiction, submitting the executables for reapproval, and then replacing or reprogramming EPROMs in each gaming machine.

Typically, personal computers use an object oriented software architecture where different software objects may be dynamically linked together prior to execution or even during execution to create many different combinations of executables that perform different functions. Thus, for example, to account for differences in gaming rules between different gaming jurisdictions, gaming software objects appropriate to a particular gaming jurisdiction may be linked at run-time which is simpler than creating a single different executable for each jurisdiction. Also, object oriented software architectures simplify the process of upgrading software since a software object, which usually represents only a small portion of the software, may be upgraded rather than the entire software. However, a disadvantage of object oriented software architectures is that they are not very compatible with EPROMs, which are designed for static executables. Thus, the gaming software regulation process described above using EPROM's may not be applicable to a gaming machine employing an object orientated software approach.

Further, in the past, gaming jurisdictions have required that EPROM based software to “run in place” on the EPROM and not from RAM i.e. the software may not be loaded into RAM for execution. Typically, personal computers load executables from a mass storage device, such as a hard-drive, to RAM and then the software is executed from RAM. Running software from an EPROM limits the size of the executable since the storage available on an EPROM is usually much less than the storage available on a hard-drive. Also, this approach is not generally compatible with PC based devices that load software from a mass storage device to RAM for execution.

In light of the above, it will be appreciated that there exist an ongoing need for improving techniques for regulating and verifying gaming machine software and other related information.

### SUMMARY OF THE INVENTION

Various aspects of the present invention are directed to different methods, systems, and computer program products for detecting at least one anomaly associated gaming data, wherein the gaming data is associated with a first casino gaming machine. A first portion of gaming data is selected for analysis. According to a specific embodiment, the first portion of gaming data corresponds to a first data pattern. A first comparison pattern relating to the first data pattern is also selected. A comparison is then performed in which the first comparison pattern is compared with a first portion of the first data pattern. Based upon the results of the comparison, a determination may be made as to whether at least one anomaly is detected in association with the first data pattern.

According to one embodiment, the first comparison pattern may correspond to a valid comparison pattern which, for example, may correspond to a portion of authenticated gaming data. When the valid comparison pattern is compared with the first portion of the first data pattern, a first anomaly may be identified in response to a determination that the first portion of the first data pattern does not match the valid comparison pattern.

According to another embodiment, the first comparison pattern may correspond to an invalid comparison pattern, which, for example, may correspond to data which is know or suspected to be invalid or unauthorized. When the valid comparison pattern is compared with the first portion of the first data pattern, a first anomaly may be identified in response to a determination that the first portion of the first data pattern matches the invalid comparison pattern. In at least one embodiment, an anomaly handling procedure may be initiated in response to a determination that an anomaly has been detected in association with the first data pattern.

Additional objects, features and advantages of the various aspects of the present invention will become apparent from the following description of its preferred embodiments, which description should be taken in conjunction with the accompanying drawings.

### BRIEF DESCRIPTION OF THE DRAWINGS

FIG. 1 shows a perspective view of an exemplary gaming machine 2 in accordance with a specific embodiment of the present invention.

FIG. 2 is a simplified block diagram of an embodiment of gaming machine 2 showing processing portions of a configuration/reconfiguration system in accordance with the present invention.

FIG. 3 is a block diagram of a gaming process file structure 300 in accordance with a specific embodiment of the present invention.

FIG. 4 is a flow chart depicting a specific embodiment of a method of verifying the authenticity of a pattern temporarily stored in RAM.

FIG. 5 is a flow chart depicting a specific embodiment of a method of parsing an address space (AS) file.

FIG. 6 is a flow chart depicting a method of locating authentic process files.

FIG. 7 is a flow chart depicting a specific embodiment of a method of initializing a pattern authenticator and pattern comparator on a gaming machine.

FIG. 8 shows a flow diagram of a Pattern Analysis Procedure 850 in accordance with a specific embodiment of the present invention.

FIG. 9 shows an example of a Pattern Comparison Procedure 900 and according us with a specific embodiment of the present invention.

FIG. 10 is a block diagram of a gaming system of the present invention.

### DETAILED DESCRIPTION OF THE PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not obscure the present invention.

Gaming Machine

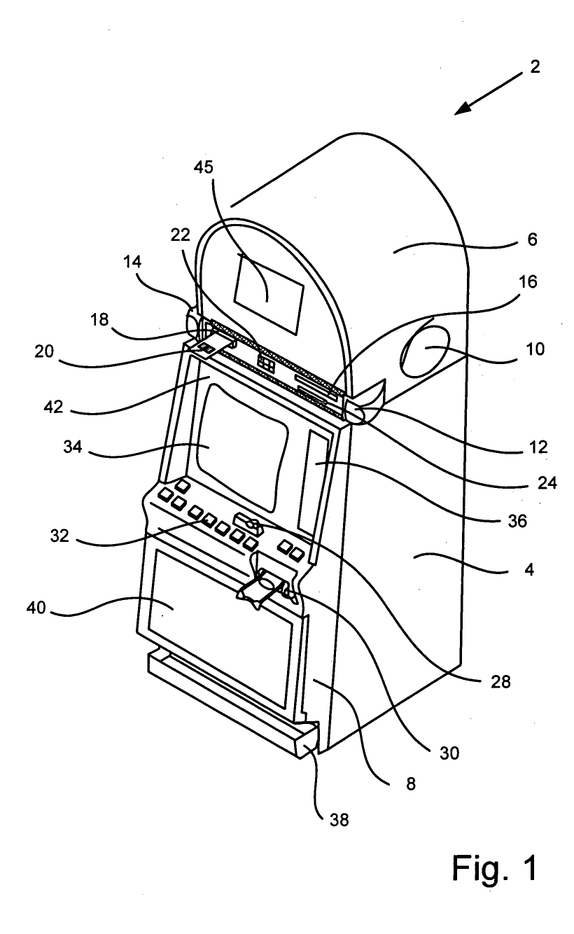

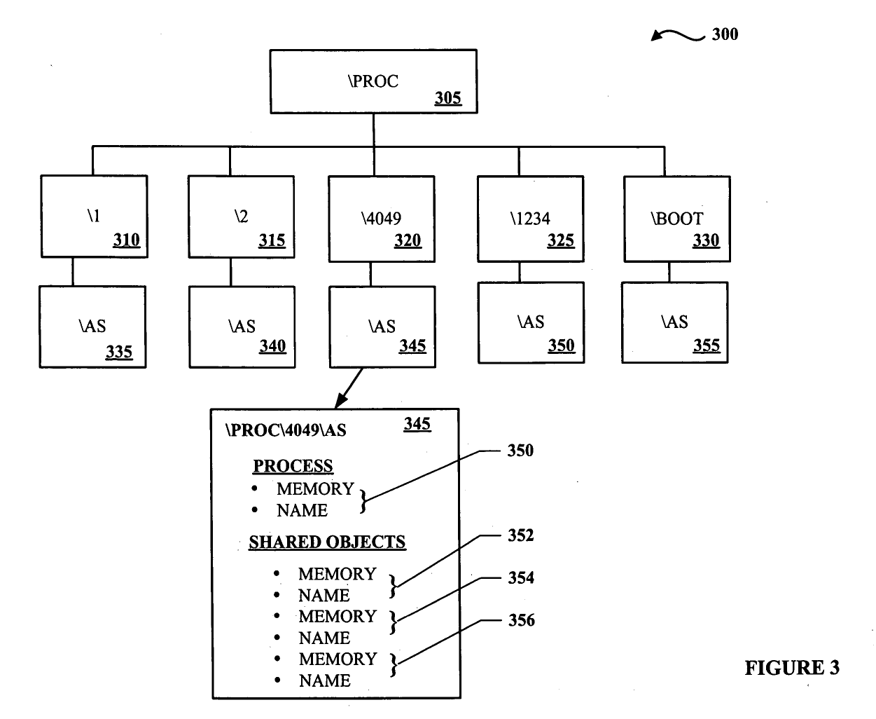

FIG. 1 shows a perspective view of an exemplary gaming machine 2 in accordance with a specific embodiment of the present invention. As illustrated in the example of FIG. 1, machine 2 includes a main cabinet 4, which generally surrounds the machine interior (illustrated, for example, in FIG. 3) and is viewable by users. The main cabinet includes a main door 8 on the front of the machine, which opens to provide access to the interior of the machine. Attached to the main door are player-input switches or buttons 32, a coin acceptor 28, and a bill validator 30, a coin tray 38, and a belly glass 40. Viewable through the main door is a video display monitor 34 and an information panel 36. The display monitor 34 will typically be a cathode ray tube, high resolution flat-panel LCD, or other conventional electronically controlled video monitor. The information panel 36 may be a back-lit, silk screened glass panel with lettering to indicate general game information including, for example, a game denomination (e.g. $0.25 or $1). The bill validator 30, player-input switches 32, video display monitor 34, and information panel are devices used to play a game on the game machine 2. According to a specific embodiment, the devices may be controlled by code executed by a master gaming controller housed inside the main cabinet 4 of the machine 2. In specific embodiments where it may be required that the code be periodically configured and/or authenticated in a secure manner, the technique of the present invention may be used for accomplishing such tasks.

Many different types of games, including mechanical slot games, video slot games, video poker, video black jack, video pachinko and lottery, may be provided with gaming machines of this invention. In particular, the gaming machine 2 may be operable to provide a play of many different instances of games of chance. The instances may be differentiated according to themes, sounds, graphics, type of game (e.g., slot game vs. card game), denomination, number of paylines, maximum jackpot, progressive or non-progressive, bonus games, etc. The gaming machine 2 may be operable to allow a player to select a game of chance to play from a plurality of instances available on the gaming machine. For example, the gaming machine may provide a menu with a list of the instances of games that are available for play on the gaming machine and a player may be able to select from the list a first instance of a game of chance that they wish to play.

The various instances of games available for play on the gaming machine 2 may be stored as game software on a mass storage device in the gaming machine or may be generated on a remote gaming device but then displayed on the gaming machine. The gaming machine 2 may executed game software, such as but not limited to video streaming software that allows the game to be displayed on the gaming machine. When an instance is stored on the gaming machine 2, it may be loaded from the mass storage device into a RAM for execution. In some cases, after a selection of an instance, the game software that allows the selected instance to be generated may be downloaded from a remote gaming device, such as another gaming machine.

As illustrated in the example of FIG. 1, the gaming machine 2 includes a top box 6, which sits on top of the main cabinet 4. The top box 6 houses a number of devices, which may be used to add features to a game being played on the gaming machine 2, including speakers 10, 12, 14, a ticket printer 18 which prints bar-coded tickets 20, a key pad 22 for entering player tracking information, a florescent display 16 for displaying player tracking information, a card reader 24 for entering a magnetic striped card containing player tracking information, and a video display screen 45. The ticket printer 18 may be used to print tickets for a cashless ticketing system. Further, the top box 6 may house different or additional devices not illustrated in FIG. 1. For example, the top box may include a bonus wheel or a back-lit silk screened panel which may be used to add bonus features to the game being played on the gaming machine. As another example, the top box may include a display for a progressive jackpot offered on the gaming machine. During a game, these devices are controlled and powered, in part, by circuitry (e.g. a master gaming controller) housed within the main cabinet 4 of the machine 2.

It will be appreciated that gaming machine 2 is but one example from a wide range of gaming machine designs on which the present invention may be implemented. For example, not all suitable gaming machines have top boxes or player tracking features. Further, some gaming machines have only a single game display—mechanical or video, while others are designed for bar tables and have displays that face upwards. As another example, a game may be generated in on a host computer and may be displayed on a remote terminal or a remote gaming device. The remote gaming device may be connected to the host computer via a network of some type such as a local area network, a wide area network, an intranet or the Internet. The remote gaming device may be a portable gaming device such as but not limited to a cell phone, a personal digital assistant, and a wireless game player. Images rendered from 3-D gaming environments may be displayed on portable gaming devices that are used to play a game of chance. Further a gaming machine or server may include gaming logic for commanding a remote gaming device to render an image from a virtual camera in a 3-D gaming environments stored on the remote gaming device and to display the rendered image on a display located on the remote gaming device. Thus, those of skill in the art will understand that the present invention, as described below, can be deployed on most any gaming machine now available or hereafter developed.

Some preferred gaming machines of the present assignee are implemented with special features and/or additional circuitry that differentiates them from general-purpose computers (e.g., desktop PC's and laptops). Gaming machines are highly regulated to ensure fairness and, in many cases, gaming machines are operable to dispense monetary awards of multiple millions of dollars. Therefore, to satisfy security and regulatory requirements in a gaming environment, hardware and software architectures may be implemented in gaming machines that differ significantly from those of general-purpose computers. A description of gaming machines relative to general-purpose computing machines and some examples of the additional (or different) components and features found in gaming machines are described below.

At first glance, one might think that adapting PC technologies to the gaming industry would be a simple proposition because both PCs and gaming machines employ microprocessors that control a variety of devices. However, because of such reasons as 1) the regulatory requirements that are placed upon gaming machines, 2) the harsh environment in which gaming machines operate, 3) security requirements and 4) fault tolerance requirements, adapting PC technologies to a gaming machine can be quite difficult. Further, techniques and methods for solving a problem in the PC industry, such as device compatibility and connectivity issues, might not be adequate in the gaming environment. For instance, a fault or a weakness tolerated in a PC, such as security holes in software or frequent crashes, may not be tolerated in a gaming machine because in a gaming machine these faults can lead to a direct loss of funds from the gaming machine, such as stolen cash or loss of revenue when the gaming machine is not operating properly.

For the purposes of illustration, a few differences between PC systems and gaming systems will be described. A first difference between gaming machines and common PC based computers systems is that gaming machines are designed to be state-based systems. In a state-based system, the system stores and maintains its current state in a non-volatile memory, such that, in the event of a power failure or other malfunction the gaming machine will return to its current state when the power is restored. For instance, if a player was shown an award for a game of chance and, before the award could be provided to the player the power failed, the gaming machine, upon the restoration of power, would return to the state where the award is indicated. As anyone who has used a PC, knows, PCs are not state machines and a majority of data is usually lost when a malfunction occurs. This requirement affects the software and hardware design on a gaming machine.

A second important difference between gaming machines and common PC based computer systems is that for regulation purposes, the software on the gaming machine used to generate the game of chance and operate the gaming machine has been designed to be static and monolithic to prevent cheating by the operator of gaming machine. For instance, one solution that has been employed in the gaming industry to prevent cheating and satisfy regulatory requirements has been to manufacture a gaming machine that can use a proprietary processor running instructions to generate the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used by the master gaming controller to operate a device during generation of the game of chance can require a new EPROM to be burnt, approved by the gaming jurisdiction and reinstalled on the gaming machine in the presence of a gaming regulator. Regardless of whether the EPROM solution is used, to gain approval in most gaming jurisdictions, a gaming machine must demonstrate sufficient safeguards that prevent an operator or player of a gaming machine from manipulating hardware and software in a manner that gives them an unfair and some cases an illegal advantage. The gaming machine should have a means to determine if the code it will execute is valid. If the code is not valid, the gaming machine must have a means to prevent the code from being executed. The code validation requirements in the gaming industry affect both hardware and software designs on gaming machines.

A third important difference between gaming machines and common PC based computer systems is the number and kinds of peripheral devices used on a gaming machine are not as great as on PC based computer systems. Traditionally, in the gaming industry, gaming machines have been relatively simple in the sense that the number of peripheral devices and the number of functions the gaming machine has been limited. Further, in operation, the functionality of gaming machines were relatively constant once the gaming machine was deployed, i.e., new peripherals devices and new gaming software were infrequently added to the gaming machine. This differs from a PC where users will go out and buy different combinations of devices and software from different manufacturers and connect them to a PC to suit their needs depending on a desired application. Therefore, the types of devices connected to a PC may vary greatly from user to user depending in their individual requirements and may vary significantly over time.

Although the variety of devices available for a PC may be greater than on a gaming machine, gaming machines still have unique device requirements that differ from a PC, such as device security requirements not usually addressed by PCs. For instance, monetary devices, such as coin dispensers, bill validators and ticket printers and computing devices that are used to govern the input and output of cash to a gaming machine have security requirements that are not typically addressed in PCs. Therefore, many PC techniques and methods developed to facilitate device connectivity and device compatibility do not address the emphasis placed on security in the gaming industry.

To address some of the issues described above, a number of hardware/software components and architectures are utilized in gaming machines that are not typically found in general purpose computing devices, such as PCs. These hardware/software components and architectures, as described below in more detail, include but are not limited to watchdog timers, voltage monitoring systems, state-based software architecture and supporting hardware, specialized communication interfaces, security monitoring and trusted memory.

For example, a watchdog timer is normally used in International Game Technology (IGT) gaming machines to provide a software failure detection mechanism. In a normally operating system, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits include a loadable timeout counter register to allow the operating software to set the timeout interval within a certain range of time. A differentiating feature of the some preferred circuits is that the operating software cannot completely disable the function of the watchdog timer. In other words, the watchdog timer always functions from the time power is applied to the board.

IGT gaming computer platforms preferably use several power supply voltages to operate portions of the computer circuitry. These can be generated in a central power supply or locally on the computer board. If any of these voltages falls out of the tolerance limits of the circuitry they power, unpredictable operation of the computer may result. Though most modern general-purpose computers include voltage monitoring circuitry, these types of circuits only report voltage status to the operating software. Out of tolerance voltages can cause software malfunction, creating a potential uncontrolled condition in the gaming computer. Gaming machines of the present assignee typically have power supplies with tighter voltage margins than that required by the operating circuitry. In addition, the voltage monitoring circuitry implemented in IGT gaming computers typically has two thresholds of control. The first threshold generates a software event that can be detected by the operating software and an error condition generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the computer.

The standard method of operation for IGT gaming machine game software is to use a state machine. Different functions of the game (bet, play, result, points in the graphical presentation, etc.) may be defined as a state. When a game moves from one state to another, critical data regarding the game software is stored in a custom non-volatile memory subsystem. This is critical to ensure the player's wager and credits are preserved and to minimize potential disputes in the event of a malfunction on the gaming machine.

In general, the gaming machine does not advance from a first state to a second state until critical information that allows the first state to be reconstructed is stored. This feature allows the game to recover operation to the current state of play in the event of a malfunction, loss of power, etc that occurred just prior to the malfunction. After the state of the gaming machine is restored during the play of a game of chance, game play may resume and the game may be completed in a manner that is no different than if the malfunction had not occurred. Typically, battery backed RAM devices are used to preserve this critical data although other types of non-volatile memory devices may be employed. These memory devices are not used in typical general-purpose computers.

As described in the preceding paragraph, when a malfunction occurs during a game of chance, the gaming machine may be restored to a state in the game of chance just prior to when the malfunction occurred. The restored state may include metering information and graphical information that was displayed on the gaming machine in the state prior to the malfunction. For example, when the malfunction occurs during the play of a card game after the cards have been dealt, the gaming machine may be restored with the cards that were previously displayed as part of the card game. As another example, a bonus game may be triggered during the play of a game of chance where a player is required to make a number of selections on a video display screen. When a malfunction has occurred after the player has made one or more selections, the gaming machine may be restored to a state that shows the graphical presentation at the just prior to the malfunction including an indication of selections that have already been made by the player. In general, the gaming machine may be restored to any state in a plurality of states that occur in the game of chance that occurs while the game of chance is played or to states that occur between the play of a game of chance.

Game history information regarding previous games played such as an amount wagered, the outcome of the game and so forth may also be stored in a non-volatile memory device. The information stored in the non-volatile memory may be detailed enough to reconstruct a portion of the graphical presentation that was previously presented on the gaming machine and the state of the gaming machine (e.g., credits) at the time the game of chance was played. The game history information may be utilized in the event of a dispute. For example, a player may decide that in a previous game of chance that they did not receive credit for an award that they believed they won. The game history information may be used to reconstruct the state of the gaming machine prior, during and/or after the disputed game to demonstrate whether the player was correct or not in their assertion. Further details of a state based gaming system, recovery from malfunctions and game history are described in U.S. Pat. No. 6,804,763, titled “High Performance Battery Backed RAM Interface”, U.S. Pat. No. 6,863,608, titled “Frame Capture of Actual Game Play,” U.S. application Ser. No. 10/243,104, titled, “Dynamic NV-RAM,” and U.S. application Ser. No. 10/758,828, titled, “Frame Capture of Actual Game Play,” each of which is incorporated by reference and for all purposes.

Another feature of gaming machines, such as IGT gaming computers, is that they often include unique interfaces, including serial interfaces, to connect to specific subsystems internal and external to the gaming machine. The serial devices may have electrical interface requirements that differ from the “standard” EIA 232 serial interfaces provided by general-purpose computers. These interfaces may include EIA 485, EIA 422, Fiber Optic Serial, optically coupled serial interfaces, current loop style serial interfaces, etc. In addition, to conserve serial interfaces internally in the gaming machine, serial devices may be connected in a shared, daisy-chain fashion where multiple peripheral devices are connected to a single serial channel.

The serial interfaces may be used to transmit information using communication protocols that are unique to the gaming industry. For example, IGT's Netplex is a proprietary communication protocol used for serial communication between gaming devices. As another example, SAS is a communication protocol used to transmit information, such as metering information, from a gaming machine to a remote device. Often SAS is used in conjunction with a player tracking system.

IGT gaming machines may alternatively be treated as peripheral devices to a casino communication controller and connected in a shared daisy chain fashion to a single serial interface. In both cases, the peripheral devices are preferably assigned device addresses. If so, the serial controller circuitry must implement a method to generate or detect unique device addresses. General-purpose computer serial ports are not able to do this.

Security monitoring circuits detect intrusion into an IGT gaming machine by monitoring security switches attached to access doors in the gaming machine cabinet. Preferably, access violations result in suspension of game play and can trigger additional security operations to preserve the current state of game play. These circuits also function when power is off by use of a battery backup. In power-off operation, these circuits continue to monitor the access doors of the gaming machine. When power is restored, the gaming machine can determine whether any security violations occurred while power was off, e.g., via software for reading status registers. This can trigger event log entries and further data authentication operations by the gaming machine software.

Trusted memory devices and/or trusted memory sources are preferably included in an IGT gaming machine computer to ensure the authenticity of the software that may be stored on less secure memory subsystems, such as mass storage devices. Trusted memory devices and controlling circuitry are typically designed to not allow modification of the code and data stored in the memory device while the memory device is installed in the gaming machine. The code and data stored in these devices may include authentication algorithms, random number generators, authentication keys, operating system kernels, etc. The purpose of these trusted memory devices is to provide gaming regulatory authorities a root trusted authority within the computing environment of the gaming machine that can be tracked and verified as original. This may be accomplished via removal of the trusted memory device from the gaming machine computer and verification of the secure memory device contents is a separate third party verification device. Once the trusted memory device is verified as authentic, and based on the approval of the verification algorithms included in the trusted device, the gaming machine is allowed to verify the authenticity of additional code and data that may be located in the gaming computer assembly, such as code and data stored on hard disk drives. A few details related to trusted memory devices that may be used in the present invention are described in U.S. Pat. No. 6,685,567 from U.S. patent application Ser. No. 09/925,098, filed Aug. 8, 2001 and titled “Process Verification,” which is incorporated herein in its entirety and for all purposes.

In at least one embodiment, at least a portion of the trusted memory devices/sources may correspond to memory which cannot easily be altered (e.g., “unalterable memory”) such as, for example, EPROMS, PROMS, Bios, Extended Bios, and/or other memory sources which are able to be configured, verified, and/or authenticated (e.g., for authenticity) in a secure and controlled manner.

According to a specific implementation, when a trusted information source is in communication with a remote device via a network, the remote device may employ a verification scheme to verify the identity of the trusted information source. For example, the trusted information source and the remote device may exchange information using public and private encryption keys to verify each other's identities. In another embodiment of the present invention, the remote device and the trusted information source may engage in methods using zero knowledge proofs to authenticate each of their respective identities. Details of zero knowledge proofs that may be used with the present invention are described in US publication no. 2003/0203756, by Jackson, filed on Apr. 25, 2002 and entitled, “Authentication in a Secure Computerized Gaming System”, which is incorporated herein in its entirety and for all purposes.

Gaming devices storing trusted information may utilize apparatus or methods to detect and prevent tampering. For instance, trusted information stored in a trusted memory device may be encrypted to prevent its misuse. In addition, the trusted memory device may be secured behind a locked door. Further, one or more sensors may be coupled to the memory device to detect tampering with the memory device and provide some record of the tampering. In yet another example, the memory device storing trusted information might be designed to detect tampering attempts and clear or erase itself when an attempt at tampering has been detected.

Additional details relating to trusted memory devices/sources are described in U.S. patent application Ser. No. 11/078,966, entitled “SECURED VIRTUAL NETWORK IN A GAMING ENVIRONMENT”, naming Nguyen et al. as inventors, filed on Mar. 10, 2005, herein incorporated in its entirety and for all purposes.

Mass storage devices used in a general purpose computer typically allow code and data to be read from and written to the mass storage device. In a gaming machine environment, modification of the gaming code stored on a mass storage device is strictly controlled and would only be allowed under specific maintenance type events with electronic and physical enablers required. Though this level of security could be provided by software, IGT gaming computers that include mass storage devices preferably include hardware level mass storage data protection circuitry that operates at the circuit level to monitor attempts to modify data on the mass storage device and will generate both software and hardware error triggers should a data modification be attempted without the proper electronic and physical enablers being present. Details using a mass storage device that may be used with the present invention are described, for example, in U.S. Pat. No. 6,149,522, herein incorporated by reference in its entirety for all purposes.

Returning to the example of FIG. 1, when a user wishes to play the gaming machine 2, he or she inserts cash through the coin acceptor 28 or bill validator 30. Additionally, the bill validator may accept a printed ticket voucher which may be accepted by the bill validator 30 as an indicia of credit when a cashless ticketing system is used. At the start of the game, the player may enter playing tracking information using the card reader 24, the keypad 22, and the florescent display 16. Further, other game preferences of the player playing the game may be read from a card inserted into the card reader. During the game, the player views game information using the video display 34. Other game and prize information may also be displayed in the video display screen 45 located in the top box.

During the course of a game, a player may be required to make a number of decisions, which affect the outcome of the game. For example, a player may vary his or her wager on a particular game, select a prize for a particular game selected from a prize server, or make game decisions which affect the outcome of a particular game. The player may make these choices using the player-input switches 32, the video display screen 34 or using some other device which enables a player to input information into the gaming machine. In some embodiments, the player may be able to access various game services such as concierge services and entertainment content services using the video display screen 34 and one more input devices.

During certain game events, the gaming machine 2 may display visual and auditory effects that can be perceived by the player. These effects add to the excitement of a game, which makes a player more likely to continue playing. Auditory effects include various sounds that are projected by the speakers 10, 12, 14. Visual effects include flashing lights, strobing lights or other patterns displayed from lights on the gaming machine 2 or from lights behind the belly glass 40. After the player has completed a game, the player may receive game tokens from the coin tray 38 or the ticket 20 from the printer 18, which may be used for further games or to redeem a prize. Further, the player may receive a ticket 20 for food, merchandise, or games from the printer 18.

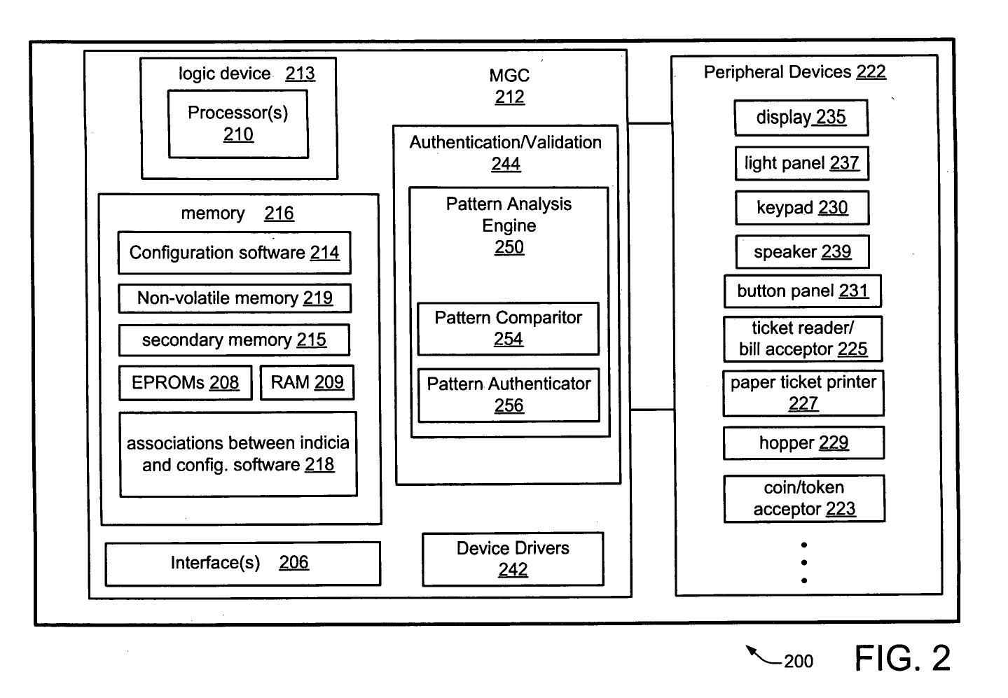

FIG. 2 is a simplified block diagram of an exemplary gaming machine 200 in accordance with a specific embodiment of the present invention. As illustrated in the embodiment of FIG. 2, gaming machine 200 includes at least one processor 210, at least one interface 206, and memory 216.

In one implementation, processor 210 and master gaming controller 212 are included in a logic device 213 enclosed in a logic device housing. The processor 210 may include any conventional processor or logic device configured to execute software allowing various configuration and reconfiguration tasks such as, for example: a) communicating with a remote source via communication interface 206, such as a server that stores authentication information or games; b) converting signals read by an interface to a format corresponding to that used by software or memory in the gaming machine; c) accessing memory to configure or reconfigure game parameters in the memory according to indicia read from the device; d) communicating with interfaces, various peripheral devices 222 and/or I/O devices 211; e) operating peripheral devices 222 such as, for example, card reader 225 and paper ticket reader 227; f) operating various I/O devices such as, for example, display 235, key pad 230 and a light panel 216; etc. For instance, the processor 210 may send messages including configuration and reconfiguration information to the display 235 to inform casino personnel of configuration progress. As another example, the logic device 213 may send commands to the light panel 237 to display a particular light pattern and to the speaker 239 to project a sound to visually and aurally convey configuration information or progress. Light panel 237 and speaker 239 may also be used to communicate with authorized personnel for authentication and security purposes.

Peripheral devices 222 may include several device interfaces such as, for example: card reader 225, bill validator/paper ticket reader 227, hopper 229, etc. Card reader 225 and bill validator/paper ticket reader 227 may each comprise resources for handling and processing configuration indicia such as a microcontroller that converts voltage levels for one or more scanning devices to signals provided to processor 210. In one embodiment, application software for interfacing with peripheral devices 222 may store instructions (such as, for example, how to read indicia from a portable device) in a memory device such as, for example, non-volatile memory, hard drive or a flash memory.

The gaming machine 200 also includes memory 216 which may include, for example, volatile memory (e.g., RAM 209), non-volatile memory 219 (e.g., disk memory, FLASH memory, EPROMs, etc.), unalterable memory (e.g., EPROMs 208), etc. The memory may be configured or designed to store, for example: 1) configuration software 214 such as all the parameters and settings for a game playable on the gaming machine; 2) associations 218 between configuration indicia read from a device with one or more parameters and settings; 3) communication protocols allowing the processor 210 to communicate with peripheral devices 222 and I/O devices 211; 4) a secondary memory storage device 215 such as a non-volatile memory device, configured to store gaming software related information (the gaming software related information and memory may be used to store various audio files and games not currently being used and invoked in a configuration or reconfiguration); 5) communication transport protocols (such as, for example, TCP/IP, USB, Firewire, IEEE1394, Bluetooth, IEEE 802.11x (IEEE 802.11 standards), hiperlan/2, HomeRF, etc.) for allowing the gaming machine to communicate with local and non-local devices using such protocols; etc. Typically, the master gaming controller 212 communicates using a serial communication protocol. A few examples of serial communication protocols that may be used to communicate with the master gaming controller include but are not limited to USB, RS-232 and Netplex (a proprietary protocol developed by IGT, Reno, Nev.).

A plurality of device drivers 242 may be stored in memory 216. Example of different types of device drivers may include device drivers for gaming machine components, device drivers for peripheral components 222, etc. Typically, the device drivers 242 utilize a communication protocol of some type that enables communication with a particular physical device. The device driver abstracts the hardware implementation of a device. For example, a device drive may be written for each type of card reader that may be potentially connected to the gaming machine. Examples of communication protocols used to implement the device drivers 259 include Netplex 260, USB 265, Serial 270, Ethernet 275, Firewire 285, I/O debouncer 290, direct memory map, serial, PCI 280 or parallel. Netplex is a proprietary IGT standard while the others are open standards. According to a specific embodiment, when one type of a particular device is exchanged for another type of the particular device, a new device driver may be loaded from the memory 216 by the processor 210 to allow communication with the device. For instance, one type of card reader in gaming machine 200 may be replaced with a second type of card reader where device drivers for both card readers are stored in the memory 216.

In some embodiments, the gaming machine 200 may also include various authentication and/or validation components 244 which may be used for authenticating/validating specified gaming machine components such as, for example, hardware components, software components, firmware components, information stored in the gaming machine memory 216, etc. In the embodiment of the FIG. 2, authentication/validation component 244 includes a pattern analysis engine 250 for facilitating authentication and/or validation operations. For example, as described in greater detail below, the pattern analysis engine 250 may be utilized for analyzing selected portions of information for one or more predetermined patterns of data. Some types of the predetermined patterns may correspond to valid, authenticated patterns of data, while other types of the predetermined patterns may correspond to patterns of data which are known or suspected to be invalid. Examples of other types of authentication and/or validation components are described in U.S. Pat. No. 6,620,047, entitled, “ELECTRONIC GAMING APPARATUS HAVING AUTHENTICATION DATA SETS,” incorporated herein by reference in its entirety for all purposes.

According to specific embodiments, the software units stored in the memory 216 may be upgraded as needed. For instance, when the memory 216 is a hard drive, new games, game options, various new parameters, new settings for existing parameters, new settings for new parameters, device drivers, and new communication protocols may be uploaded to the memory from the master gaming controller 104 or from some other external device. As another example, when the memory 216 includes a CD/DVD drive including a CD/DVD designed or configured to store game options, parameters, and settings, the software stored in the memory may be upgraded by replacing a first CD/DVD with a second CD/DVD. In yet another example, when the memory 216 uses one or more flash memory 219 or EPROM 208 units designed or configured to store games, game options, parameters, settings, the software stored in the flash and/or EPROM memory units may be upgraded by replacing one or more memory units with new memory units which include the upgraded software. In another embodiment, one or more of the memory devices, such as the hard-drive, may be employed in a game software download process from a remote software server.

It will be apparent to those skilled in the art that other memory types, including various computer readable media, may be used for storing and executing program instructions pertaining to the operation of the present invention. Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). The invention may also be embodied in a carrier wave traveling over an appropriate medium such as airwaves, optical lines, electric lines, etc. Examples of program instructions include both machine code, such as produced by a compiler, and files including higher level code that may be executed by the computer using an interpreter.

Additional details about other gaming machine architectures, features and/or components are described, for example, in U.S. patent application Ser. No. 10/040,239, entitled, “GAME DEVELOPMENT ARCHITECTURE THAT DECOUPLES THE GAME LOGIC FROM THE GRAPHICS LOGIC,” and published on Apr. 24, 2003 as U.S. Patent Publication No. 20030078103, incorporated herein by reference in its entirety for all purposes.

As stated previously, gaming regulatory and/or security restrictions typically require that an electronic gaming system provide both security and authentication features for its components. For this reason, gaming commissions have heretofore required that all software components of an electronic gaming system be stored in unalterable memory, which is typically an unalterable ROM (e.g., EPROM). While such electronic casino gaming systems have been found to be useful in promoting casino game play, the restriction requiring that the casino game program be stored in unalterable ROM memory results in a number of disadvantageous limitations. For example, due to the limited capacity of the ROM storage media traditionally used to hold the program, the scope of game play available with such systems is severely limited.

One technique for overcoming such a limitation is to enable the gaming machine to retrieve at least a portion of its game code from a remote location such as, for example, a remote game server. One example of a game server that may be used with the present invention is described in co-pending U.S. patent application Ser. No. 09/595,798, filed on Jun. 16, 2000, entitled “Using a Gaming Machine as a Server” which is incorporated herein in its entirety and for all purposes. The game server might also be a dedicated computer or a service running on a server with other application programs. In order to gain approval in most gaming jurisdictions, however, it must be demonstrated that sufficient safeguards are in place to prevent an operator or player of a gaming machine from manipulating hardware and/or software in a manner that gives them an unfair (and some cases) an illegal advantage.

According to at least one embodiment of the present invention, gaming software and/or other code executed on the gaming machine 200 by the master gaming controller 212 may be periodically verified, for example, by comparing software stored in memory 216 for execution on the gaming machine 200 with certified copies of the software stored on one or more trusted memory sources which, for example, may reside at the gaming machine and/or at a remote location. In one implementation, such a technique may be implemented using, for example, a pattern comparator 254 and a pattern authenticator 256 such as those illustrated in FIG. 2.

In a specific embodiment where the patterns to be analyzed correspond to selected portions of software code which may be executed by the master gaming controller 212, the pattern comparator may be configured or designed to compare at least some portion(s) of the gaming software scheduled for execution on the gaming machine at a particular time with authenticated gaming software stored at one or more trusted memory source(s) which are accessible to the gaming machine 200. The trusted memory source(s) may comprise one or more file storage devices which, for example, may be located at the gaming machine 200, on other gaming machines, on remote servers, or combinations thereof. During operation of the gaming machine, the pattern comparator periodically checks the gaming software programs being executed by the master gaming controller 212 since, for example, the gaming software programs executed by the master gaming controller 212 may vary with time. Additional details relating to the pattern comparator functionality are described, for example, with respect to FIGS. 3-5, and 8-9 of the drawings.

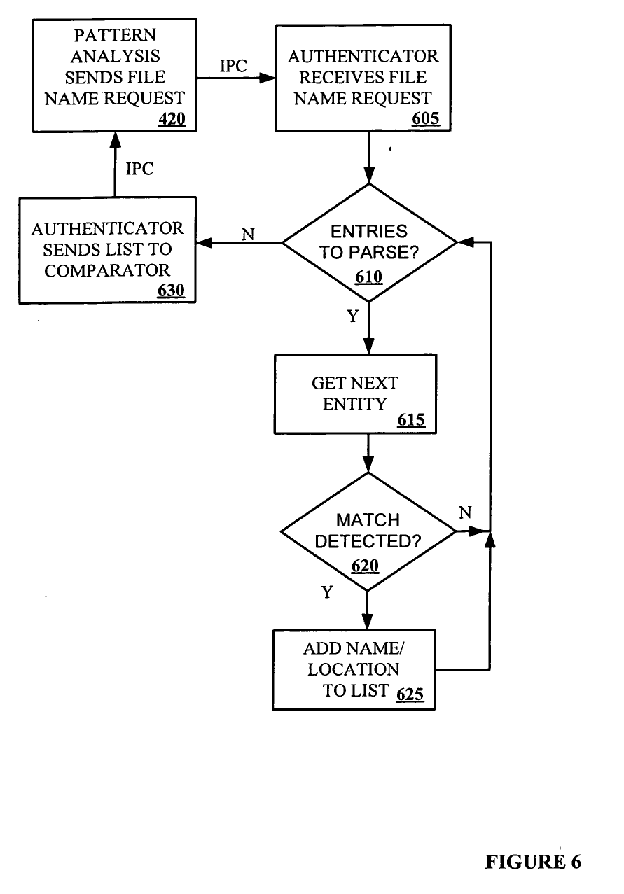

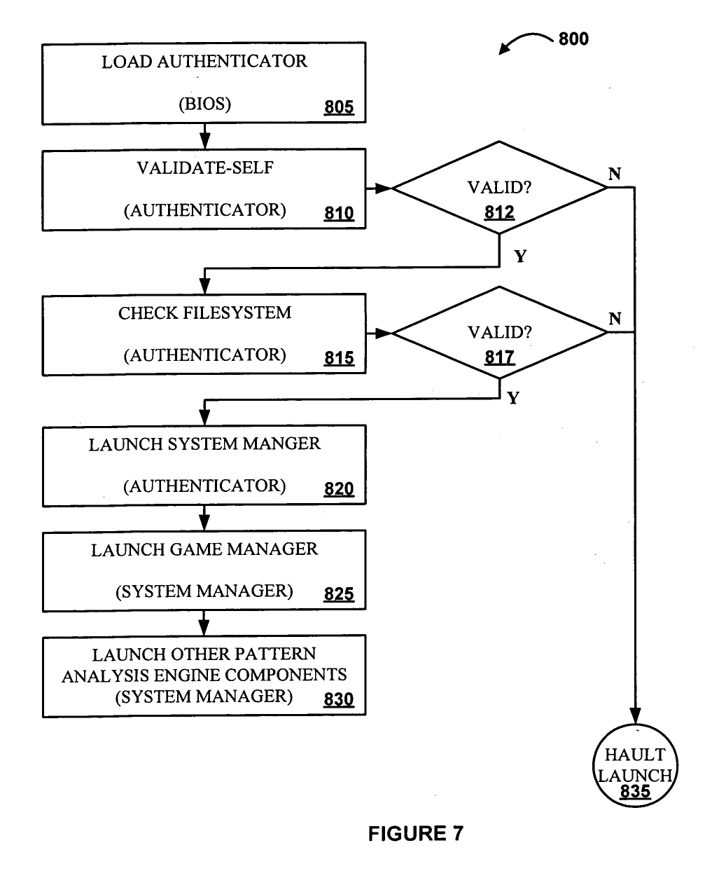

In the above-described embodiment, the pattern authenticator (described in greater detail, for example, with respect to FIGS. 6-7 and 8-9) may be configured or designed to access, at the trusted memory source(s), authenticated portions of the gaming software being checked by the pattern comparator. During the boot process for the gaming machine 200 (see e.g., FIG. 7), the pattern authenticator may be loaded from an EPROM such as 208. The master gaming controller 212 executes various gaming software programs using one or more processors 210. During execution, a software program may be temporarily loaded into the memory 216 such as, for example, RAM 209. Depending on the current operational state of the gaming machine, the types of software programs loaded in the memory 216 may vary with time. For instance, when a game is presented, particular software programs or executable code used to present a complex graphical presentation may be loaded into memory 216. However, when the gaming machine 200 is idle, these graphical software programs may not be loaded into the RAM.

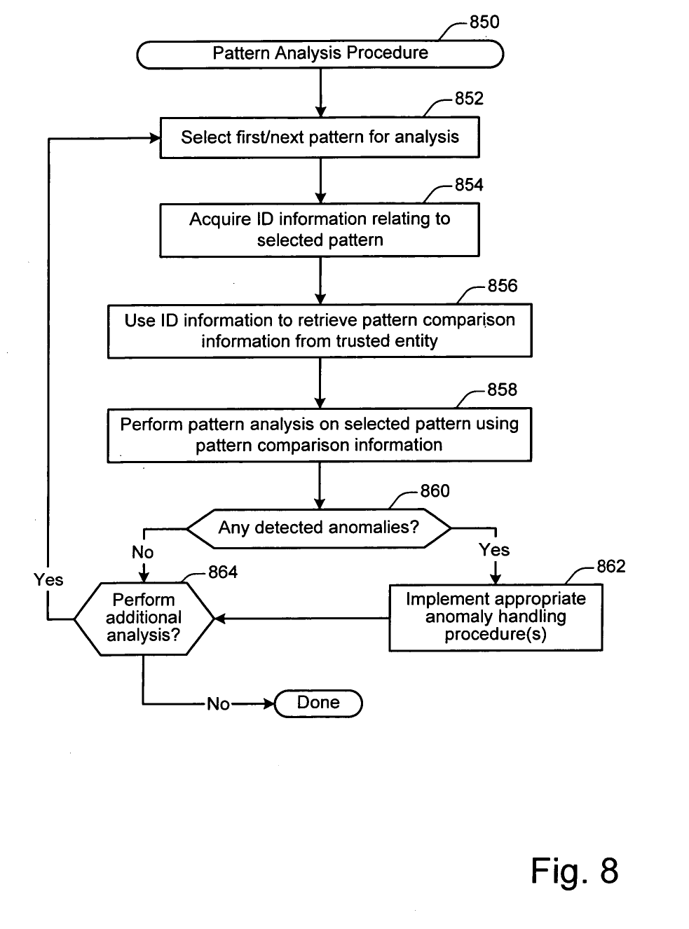

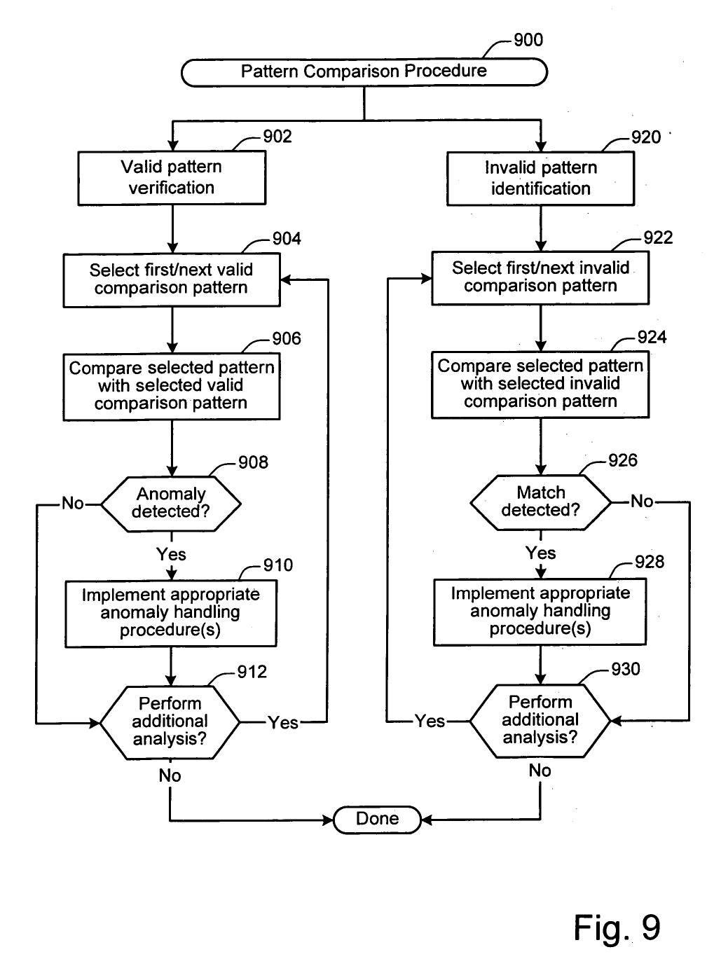

According to a specific embodiment, the pattern comparator and pattern authenticator may execute simultaneously with the execution of the other software programs on the gaming machine. Thus, the gaming machine is designed for “multi-tasking” i.e. the execution of multiple software programs simultaneously. In at least one embodiment, the pattern comparator and pattern authenticator processes may be used to verify executable code. However, the present invention is not limited to the verification of executable code. More specifically, as described in greater detail below (e.g., with respect to FIGS. 8-9), the technique of the present invention may be used: (1) to verify selected patterns of files, images, data, code, or other information; and/or (2) to identify unauthorized or anomalous patterns of files, images, data, code, or other information associated with gaming machine operations.

Details of gaming software programs that may be executed on a gaming machine and an object oriented software architecture for implementing these software programs are described in co-pending U.S. patent application Ser. No. 09/642,192, filed on Aug. 18, 2000 and entitled “Gaming Machine Virtual Player Tracking and Related Services,” which is incorporated herein in its entirety and for all purposes and U.S. Pat. No. 6,804,763, entitled “High Performance Battery Backed Ram Interface” which is incorporated herein in its entirety and for all purposes.

Various gaming software programs, loaded into memory 216 for execution, may be managed as “processes” by an operating system used on the gaming machine 200. The operating system may also perform process scheduling and memory management. An example of an operating system that may be used with the present invention is the QNX operating system provided by QNX Software Systems, LTD (Kanata, Ontario, Canada).

The pattern comparator may use information provided by the operating system, such as process information for processes scheduled by the operating system, to select gaming software executables for pattern analysis, verification, and/or validation. According to a specific embodiment, pattern validation may involve the comparing of a selected pattern against a known, valid instance of that pattern. For example, the Code Comparator process may be configured or designed to compare patterns executing in memory against their counterparts on the hard drive. Pattern verification may involve the comparing of a selected pattern against one or more known or suspected invalid patterns such as, for example, the comparing of a selected, pattern against patterns of known viruses.

According to a specific embodiment, the QNX operating system may provide a list of process that are currently being executed on the gaming machine and information about each process (See, e.g., FIG. 3). With QNX, the pattern comparator and pattern authenticator may be processes scheduled by the operating system. The present invention is not limited to an operating system such as QNX. The pattern comparator may be used with other operating systems that provide information about the software programs currently being executed by the operating system and the memory locations of these software units during execution to verify the gaming software programs executing on the gaming machine. For instance, the pattern comparator may be used with Linux (Redhat, Durham, N.C.), which is an open source Unix based operating system, or Windows NT or MS Windows 2000 (Microsoft, Redmond, Wash.). Windows utilizes a RAM image on the hard drive to create a virtual paging system to manage executable code. The present invention may be applied to verify executable code managed by a virtual paging system. Further, the executable formats and dynamic link libraries between operating systems may vary. The present invention may be applied to different executable formats and link libraries used by a particular operating system and is not limited to the format and libraries of a particular operating system.

According to a specific embodiment, the pattern authenticator searches a file system available to the gaming machine for certified/authentic copies of gaming software programs currently being executed by the gaming machine. The file system may be distributed across one or more file storage devices. The certified/authentic copies of gaming software programs may be certified after a regulatory approval process as described above. The certified/authentic copies of gaming software programs may be stored in a “static” mode (e.g. read-only) on one or more file storage devices located on the gaming machine 200 such as file storage device 214 or EPROM 208. The file storage devices may be a hard-drive, CD-ROM, CD-DVD, static RAM, flash memory, EPROM's, compact flash, smart media, disk-on-chip, removable media (e.g. ZIP drives with ZIP disks, floppies or combinations thereof.

The file system used by the pattern authenticator may be distributed between file storage devices located on the gaming machine or on remote file storage devices.

One advantage of the pattern analysis techniques of the present invention is that gaming software programs executed in a dynamic manner (e.g., different gaming software programs may be continually loaded and unloaded into memory for execution) may be regularly checked to ensure the software programs being executed by the gaming machine are certified/authentic programs. The verification process may be used to ensure that approved gaming software is operating on the gaming machine, which may be necessary to satisfy gaming regulatory entities within various gaming jurisdictions where the gaming machine may operate. The gaming machine may be designed such that when uncertified, invalid and/or inauthentic programs are detected, an error condition is generated and the gaming machine shuts down. Thus, the present invention enables software architectures and hardware developed for personal computers to be applied to gaming machines.

For purposes of illustration, aspects of the pattern analysis techniques of the present invention will now be described by way of illustration with respect to FIGS. 3-7 of the drawings which relate to a specific embodiment where the patterns to be analyzed correspond to selected portions of software code which may be executed by the master gaming controller 212.

FIG. 3 is a block diagram of a gaming process file structure 300 in accordance with a specific embodiment of the present invention. As a player utilizes a gaming machine in the manner described above, many different software programs may be executed by the gaming machine. As different gaming software programs are executed by the gaming machine, an operating system running on the gaming machine assign the programs memory location in RAM and then schedule and track the execution of each program as “processes.” The pattern analysis engine (e.g., 250), which may also be configured as a process, may be used to verify itself and the other processes being executed from RAM.

In one example, every time a process is launched in the operating system, a special directory, such as 310, 315, 320, 325 and 330, is created under the directory “/proc” 305 (e.g. the process directory) in the operating system. The name of this directory is identical to the process ID number (PID) of the process. For instance, process directories corresponding to process ID numbers “1”, “2”, “4049”, “1234” and “6296” are stored under the “/proc” 305 directory. The process directories listed under the “/proc” directory 305 may vary as a function of time as different processes are launched and other process are completed.

In one embodiment, under each PID directory, such as 310, 315, 320, 325 and 330, an address space (AS) file, titled “AS”, may be stored. The AS files, such as 335, 340, 345, 350 and 355 may contains various information about its parent process. Items stored in this file may include, among other things, the command line name used to launch the program and it's location in RAM (e.g. 350) and the names and location in RAM of the shared objects (so) that the process uses (e.g. 352, 354 and 356). A shared object is a gaming software program that may be shared by a number of other gaming software programs.

The shared objects used by a process on the gaming machine may vary with time. Thus, the number of shared objects such as 352, 354 and 356 used by a process may vary with time. For instance, a process for a game presentation on a gaming machine may launch various graphical shared objects and audio shared objects during the presentation of a game on the gaming machine and various combinations of these shared objects may be used at various times in the game presentation. For example, a shared object for a bonus game presentation on the gaming machine may only be used when a bonus game is being presented on the gaming machine. Hence, a process for a bonus game presentation may be launched when a bonus game presentation is required and the process may terminate when the bonus game presentation is completed. When the game presentation process uses the bonus game presentation shared object, the launching and the termination of the bonus game presentation shared object may be reflected in the AS file for the game presentation process.

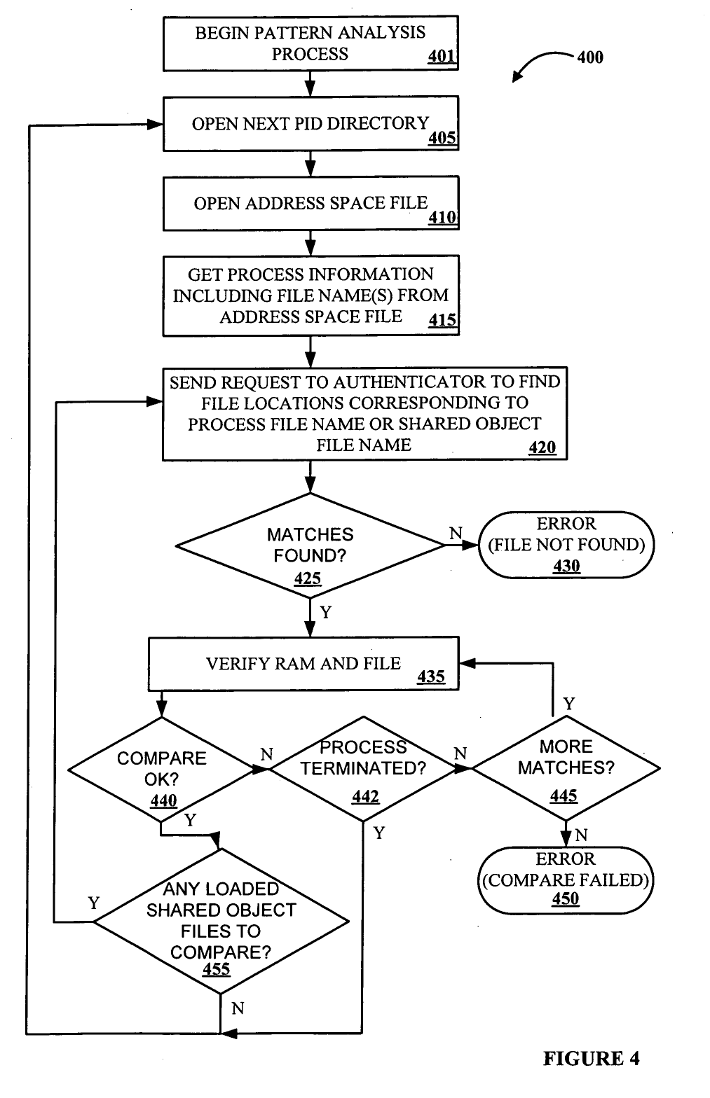

The pattern analysis engine may use the AS files to determine which game related processes are currently being executed on the gaming machine. The pattern analysis engine may also be a process designated in the “/proc” directory 305. Also, in the “/proc” directory there may exist one or more directories that are not representations of process Ids. These include, but are not limited to, SELF, boot 330, ipstats, mount, etc. When parsing the “/proc” directory, these directories are skipped as they do not represent game related code. Once a valid directory is found, e.g., “4049” 320, it is opened and the “AS” file in it may parsed. A detailed method of using the “AS” file as part of a code validation/authentication process is described with respect to FIG. 4.

FIG. 4 is a flow chart depicting a method 400 of validating the authenticity of a process temporarily stored in RAM on a gaming machine using the pattern analysis engine in accordance with one embodiment of the present invention. As described above, the pattern analysis engine may be used with other operating systems which may affect the comparison process. Thus, the following example is provided for illustration purposes only.

In 401, a pattern analysis process, which, for example, may be implemented by the pattern analysis engine 250, is instantiated. Various processes may be scheduled for execution on the gaming machine at the same time. Thus, the operating system determines the order in which to execute each process. An execution priority may be assigned to each process. Thus, processes with a higher priority will tend to execute before lower priority processes scheduled to run on the gaming machine.

In one embodiment, the pattern analysis process may be scheduled to run at a low priority where the pattern analysis process process may be automatically launched at regular intervals by the operating system. Therefore, during its execution, the pattern analysis process may be preempted by other higher priority processes that may add/remove/reload additional processes. For this reason, the design of the pattern analysis process may include methods to detect when the execution of the pattern analysis process has been preempted and methods to respond to the addition/removal/reloading of processes that may have occurred while the pattern analysis process was preempted.

In other embodiments, the pattern analysis process may not always be a low-level process. During certain states of the gaming machine, the pattern analysis process may be scheduled as a high priority process. For instance, when the pattern analysis process has not been executed over a specific period of time, the priority of the pattern analysis process may be increased until the process is completed. In another example, the pattern analysis process may be launched and complete its tasks without interruption from other processes.

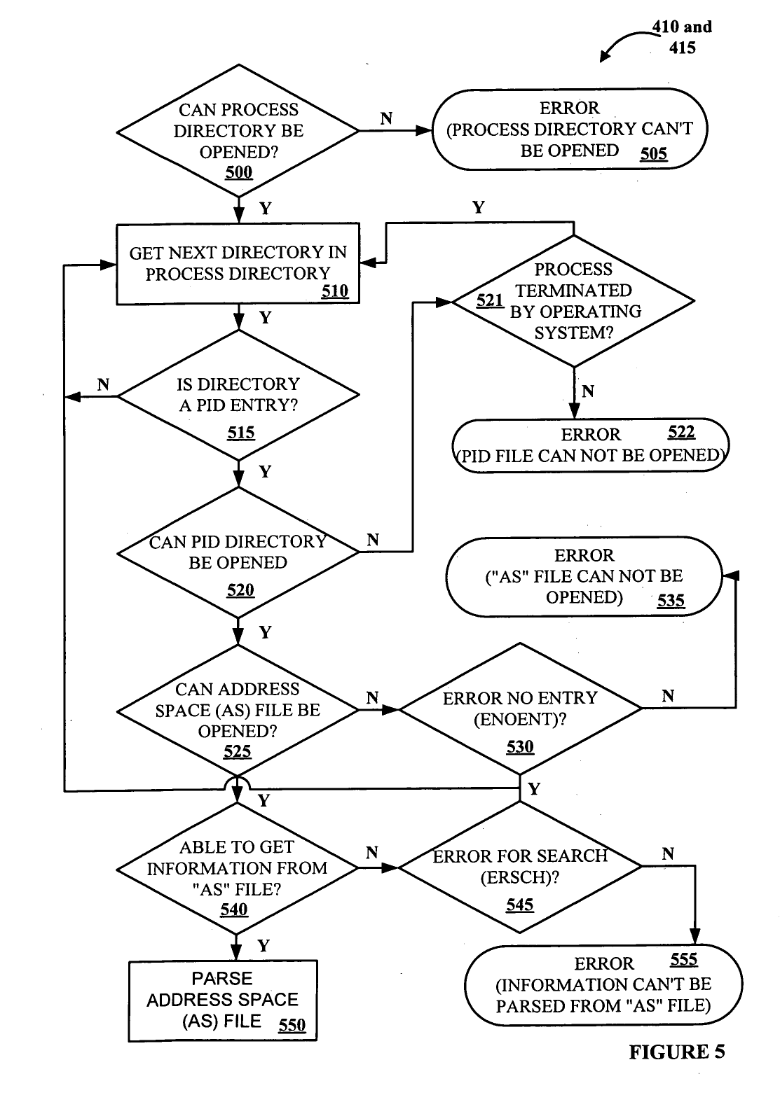

In 405, after the pattern analysis process has been launched, it begins to check each process instantiated by the operating system that is listed under the “/proc” directory as described with respect of FIG. 3. It is preferable that the pattern analysis process be able to open the “/proc” directory. When it can not open the directory, an error is generated as described with respect to FIG. 5. The pattern analysis process may check PID directories in a certain range of integer values. PID directories within the range of integer values may correspond to gaming software programs verified by the pattern analysis process, while PID directories outside of the integer range may not be verified by the pattern analysis process.

In 410, the pattern analysis process opens the “AS” as described with respect to FIG. 3. When the “AS” file can not be opened, an error condition may be triggered. In 415, when the “AS” file is opened, the pattern analysis process parses process information such as an executable file name corresponding to the process and a temporary memory location of the process in RAM. In addition, the pattern analysis process may parse from the “AS” file the executable file names and temporary memory locations of the processes in RAM for one or more shared objects used by the process. When information from the “AS” file can not be obtained by the pattern analysis process a number of error conditions may be triggered. Further details of 410 and 415 involving opening and parsing the “AS” file are described with respect to FIG. 5.

In 420, when the pattern analysis process has obtained a file name corresponding to the process in the “AS” file, the location of the file is requested, for example, from the pattern authenticator. According to a specific embodiment, the pattern authenticator may be configured to include pattern identification functionality. The location of the file may be requested from the pattern authenticator via, for example, an inter process communication (IPC) from the pattern analysis process. IPCs allow processes instantiated by the operating system to share information with one another.

According to a specific embodiment, when asking the pattern authenticator for the location(s) of a given file, the full file name and a vector of string pointers, i.e., vector <String *>, are passed. The pattern authenticator application program interface (API) fills the vector with a list of paths to file locations corresponding to the file name received from pattern authenticator and returns the vector to the pattern analysis process via an IPC. The list of paths correspond to matching files found on the file storage media (e.g., memory 216) identified by the pattern authenticator. If no matches are found, the vector returned by the authenticator is empty or may contain an error message. Details of one search method used by the pattern authenticator is described with respect to FIG. 6.

In 425, the pattern analysis process examines the vector returned by the pattern authenticator. When the vector is empty, the process identified by the pattern analysis process may be considered a rogue process. In 430, an error condition, such as “file not found”, may be reported by the pattern analysis process. The error condition may cause the system manager on the gaming machine to take an action such as shutting down, rebooting, calling an attendant, entering a “safe” mode and combinations thereof.

In 435, operating instructions temporarily stored in RAM corresponding to a process executing on the gaming machine are compared with a certified/authentic operating instructions stored in a file located by the pattern authenticator. In the operating system for one embodiment of the present invention, files are stored using an Executable and Linking Format (ELF). Details of the ELF format are described as follows and then a comparison by the pattern analysis process of operating instructions for a process stored in RAM with operating instructions stored in a corresponding ELF file are described.

Generally, there are three ELF file types: 1) executable, 2) relocatable and 3) shared object. Of these three, only the executable and shared object formats, which may be executed by the operating system, are used by the pattern analysis process. There are five different sections that may appear in any given ELF file including a) an ELF header, b) a program header table, c) section header table, d) ELF sections and e) ELF segments. The different sections of the ELF file are described below.

The first section of an ELF file is always the ELF Header. It is the only section that has a fixed position and is guaranteed to be present. The ELF header has three tasks: 1) it details the type of file, target architecture, and ELF version, 2) it contains the location within the file of the program headers, section headers, and string tables as well as their size and 3) it contains the location of the first executable instruction.

The Program Header Table is an array of structures that can each describe either a segment in the file or provide information regarding creating an executable process image. Both the size of each entry in the program header table and the number of entries reside in the ELF header. Every entry in the program header table includes a type, a file offset, a physical and virtual addresses, a file size, a memory image size and a segment alignment. Like the program header table, the section header table contains an array of structures. Each entry in the section header table contains a name, a type, a memory image starting address, a file offset, a size an alignment and a section purpose. For every section in the file, a separate entry exists in the section header table.

Nine different ELF section types exist. These consist of executable, data, dynamic linking information, debugging data, symbol tables, relocation information, comments, string tables and notes. Some of these types are loaded into the process image, some provide information regarding the building of the process image, and some are used when linking object files. There are three categories of ELF segments: 1) text, 2) data and 3) dynamic. The text segment groups executable code, the data segment groups program data, and the dynamic segment groups information relevant to dynamic loading. Each ELF segment consists of one or more sections and provide a method for grouping related ELF sections. When a program is executed, the operating system interprets and loads the ELF segments to create a process image. If the ELF file is a shared object file, the operating system uses the segments to create the shared memory resource.

In 435, the comparison process may include first verifying the ELF header and then verifying the program blocks. When a program is temporarily loaded in RAM as a process, only the program blocks that are marked as loadable and executable in the ELF file will exist in RAM and, therefore, are the only ones verified.

To validate a process loaded in RAM, the pattern analysis process opens a file on the storage device where the file is located. The pattern analysis process begins with the first file in the vector of file paths sent to the pattern analysis process by the pattern authenticator. In 415, the RAM address of the loaded process is obtained from “AS” when the “AS” file is parsed. The RAM address marks the start of the loaded ELF header. The loaded ELF header is verified against the corresponding ELF header from the file on the storage device. Since the size of the ELF header is fixed, this comparison is a straight forward byte comparison. If the ELF header matches, the program blocks are then checked.

In at least one implementation, pattern comparison operations may be performed by the pattern comparator 254. The pattern comparator may consider two things when comparing ELF program blocks. First, what program blocks were loadable and/or executable and second, where do each of the program blocks reside in RAM. The number of program headers resides in the ELF header. Each of these headers, in turn, contains the offset to the code block that they represent as well as whether or not it is loadable or executable.

The starting address for where, in RAM, the code exists, resides in the “AS” file. This is the same for the file except that the starting address of the file pointer is used to determine the start of the program. All executable/loadable program blocks in RAM are compared against the file stored on the storage media. Data blocks which may vary as the program is executed are not usually checked. However, in some programs, “fixed” or static data blocks may be checked by the pattern comparator. In one embodiment, when all blocks check out, the comparison is deemed successful. In another embodiment, only a portion of the program blocks may be checked by the pattern comparator. To decrease the time the comparison process takes, partial or random section portions of code may be compared. In one embodiment, a bit-wise comparison method is used to compare code. However, the method is not limited to a bit-wise comparison other comparison methods may be used or combinations of comparison methods may be used.

During the file comparison process, a mismatch may result from several different conditions including but not limited to the conditions described as follows. First, it is possible that the pattern analysis process was pre-empted and that the process that is currently being verified was terminated. Second, it is also possible that the RAM contents or file contents for the process in question may have been corrupted. Third, the file being compared could have the same name as the file used to launch to process but not actually be the same file. This condition may occur, for example, when the pattern authenticator returns a vector with multiple file paths corresponding to the file name sent to the pattern authenticator by the pattern analysis process. Fourth, the process executing in RAM may have been altered in some manner in an attempt to tamper with the gaming machine.

In 440, the pattern analysis process checks the status of the RAM and file compare process. In 445, when the compare is accepted (the conditions for accepting the compare may be varied), the pattern analysis process begins to check any shared objects for the process obtained from the “AS” file. When the process does not use shared objects, the pattern analysis process continues to the next PID directory in 405. When the process is using one or more shared objects, the pattern analysis process sends a request to the pattern authenticator to find file locations corresponding to the file name for the shared object in 420.

In 442, when a mismatch occurs, to determine whether the process has terminated, the “AS” file for the process is re-parsed and the newly obtained contents are compared against the original contents obtained initially. When the “AS” file is no longer accessible, the process was terminated during the compare process and the comparison is aborted and an error condition is not generated. When the “AS” file can be re-parsed but the file name stored within the “AS” file has changed, then the original process may been terminated and a new process may have been started with the same process identification number (PID). In this case, the comparison process is aborted and error condition is not generated.

In 445, when the newly obtained contents from the “AS” file match the original contents of the “AS” file in 442, the comparison process continues with the next file from the matching file list in the vector that was obtained via the pattern authenticator process. When the pattern analysis process reaches the end of this vector list without matching the process, a rogue process may be running and an error condition is reported in 450 to the system manager. In 440, when a comparison fails because of a RAM and/or file corruption, the pattern analysis process may check whether the process has terminated in 442 and continue to the next the file in the authenticator file list in 445. Once the end of the authenticator file list is reached, the pattern analysis process will declare a rogue process and report the error in 450.

FIG. 5 is a flow chart depicting a method of parsing an address space (AS) file as described with respect to 410 and 415 in FIG. 4. The method is presented for illustrative purposes as it is specific to the QNX operating system. A similar method may be developed for different operating systems such as Linux or Windows NT. In 500, the pattern analysis process attempts to open the process directory (“/proc” as described with reference to FIG. 3), which is provided by the operating system and contains a list of all the processes currently scheduled for execution. In 505, when the process directory can not be opened, an error is sent by the pattern analysis process to the system manager indicating the process directory can not opened. In one example, the process directory as well as other directories below the process directory may be inaccessible because an access privilege has been set on the directory that prevents access by the pattern analysis process. Access privileges for directories are well know in UNIX based operating systems such as QNX.

In 510, when the process directory can be opened, the pattern analysis process selects the next directory in the list of PID directories under the process directory. The PID directories are listed as integers. The pattern analysis process, which may be repeatedly pre-empted by other process while performing the code comparison, stores which integer PID it is currently comparing and then proceeds to the next closet integer after the compare on the current process is completed. In 515, the pattern analysis process compares the selected integer PID number with a range of integers. Not all processes are necessarily compared by the pattern analysis process. In general, only processes within a particular numerical range corresponding to gaming software that has been certified are verified by the pattern analysis process. When the PID directory number does not fall within the range of integers checked by the pattern analysis process or the PID directory has a text name, such as boot, the pattern analysis process proceeds to the next PID directory in the process directory in 510.

When the PID directory is within the integer range of processes which the pattern analysis process checks, in 520, the pattern analysis process attempts to open the PID directory. In 521, when the PID directory can not be opened, the comparator determines whether the process was terminated by the operating system. When the process was terminated by the operating system, the pattern analysis process moves to the next directory in the process directory in 510. In 522, when the PID directory can not be opened and the process was not terminated by the operating system, an error message is posted to the operating system. A way of tampering with the gaming machine may be to generate a process that can not be checked by the pattern analysis process and/or other components of the pattern analysis engine.

In 525, when the PID directory can be opened, the pattern analysis process attempts to open the Address Space (AS) file as described with reference to FIG. 2. The “AS” file may contain a process memory address location, a process executable file name, shared object memory address locations used by the process and shared object executable file names corresponding to the shared objects. In 540, the pattern analysis process attempts to read the “AS” file. In 550, when the file is readable, the pattern analysis process continues with the comparison process according to 420 in FIG. 4.

In 540 when the pattern analysis process can not get information from the “AS” file, the pattern analysis process checks for the “Error for Search (ESRCH)” error condition in 545. The error code ESRCH is returned when the requested file does not exist and indicates that the process the pattern analysis process was trying to access was removed. When the pattern analysis process detects this error code, the error is ignored and the pattern analysis process continues to the next PID directory in 510. In 555, when an ERSCH error condition is not detected, an error message is sent to the system manager indicating the “AS” file can not be parsed. The “AS” may not be parsable for a number of reasons. For instance, the data in the “AS” may have been corrupted in some manner that prevents the pattern analysis process from reading the file.

In 525 when the “AS” can not be opened, only one error code, “Error No Entry (ENOENT)” is tolerated. The ENOENT error code is returned when the requested file does not exist. It indicates that the process the pattern analysis process was trying to access was removed by the operating system. In 530, the pattern analysis process checks for the ENOENT code. When an ENOENT error code has been generated, the code is ignored and the pattern analysis process moves on to the next PID directory in 510. The ENOENT code may have been generated because the pattern analysis process was preempted during its operation by the execution of one or more higher priority processes. While the higher priority processes were being executed, the process that the pattern analysis process was checking may have been terminated. When any other error code is detected by the pattern analysis process, in 535 an error message is sent to the operating system indicating that the “AS” can not be opened. For instance, the “AS” file may exist but the pattern analysis process may not have the access privilege to open the file which would generate an error condition other than ENOENT and hence an error condition in 535.

FIG. 6 is a flow chart depicting a method of locating authentic process files. In 420, as described above, the pattern analysis process sends a file name request via an interprocess communication to the pattern authenticator. In 605, via the pattern authenticator application program interface, the pattern authenticator receives a file name. The pattern authenticator searches through a list of file names where each file name corresponds to certified executable gaming software program. The certified gaming software programs may be stored on storage media, i.e. one or more file storage devices, located within the gaming machine, located outside of the gaming machine or combinations thereof. A portion of the certified executable gaming software programs may have been approved by a gaming regulatory agency in a gaming jurisdiction for use on gaming machines in the gaming jurisdiction. In cases where a gaming jurisdiction does not require certification of a particular software program, the gaming software program may also be certified as authentic by the gaming manufacturer for security reasons. Further details of pattern authenticator application may be found in co-pending U.S. application Ser. No. 10/458,846, filed on Jun. 10, 2003, by LeMay, et al., “Method and Apparatus for Software Authentication” which is incorporated in its entirety and for all purposes.

In 610, the pattern authenticator determines whether it has reached an end of the list of certified file names. When the pattern authenticator has not reached the end of the list, in 615, the pattern authenticator gets the next file name of the list. In 620, when the name from the list matches the name received from the pattern analysis process, the path to the file, which may be the location of the file in a file structure stored on a file storage device, is added to a list of matched files detected by the pattern analysis process.

The list of matched files is stored in a vector which may contain zero files when no files have been matched to a plurality of files when multiple matches have been detected by the pattern analysis process. In the case where multiple matches have been detected, the multiple files may reside on a common file storage device or the multiple files may reside on different file storage devices. In 620, when a match is not detected, the pattern authenticator checks the next file entity on the list for a match. In 630, after the entire list of certified file names has been searched, the authenticator sends a vector, which may be empty, containing a list of matches detected by the pattern authenticator, to the pattern comparator via an IPC.

FIG. 7 is a flow chart depicting a method 800 of initializing an authenticator and other components of the pattern analysis engine on a gaming machine. In 805, an authenticator such as, for example, the pattern authenticator 256, is loaded by the BIOS from an EPROM (see, e.g., FIG. 2). The pattern authenticator may be stored on an EPROM or other trusted memory source for security and gaming approval reasons. The EPROM storing the pattern authenticator can be submitted for approval to a gaming jurisdiction. Once the EPROM has been approved, as was previously described, a unique signature may be generated for the EPROM. The unique signature may be checked when the EPROM is installed on the gaming machine in the local gaming jurisdiction. Since software stored on the EPROM is generally difficult to alter, the use of the EPROM may also prevent tampering with the gaming machine.

In 810, after the pattern authenticator has been loaded from the EPROM, the pattern authenticator may validate itself. For instance, a CRC may be performed on the authenticator software to obtain a CRC value. The CRC value may be compared with a certified CRC value stored at some location on the gaming machine. In 812, the validation check is performed. When the authenticator is not valid, the initialization of the gaming machine is halted in 835 and the gaming machine may be shutdown or placed in a safe mode. In 815, the pattern authenticator may compare a list of certified software programs stored in the EPROM with a list of software programs available on the gaming machine. As an example, the EPROM may contain about 1 Megabyte of memory available for storage purposes but is not limited to this amount. The pattern authenticator may also perform other files system checks.

In 817, if file system has not been validated, the launch of the gaming machine is halted and the gaming machine may be shutdown or placed in a safe mode in 835. However, if the file system has been validated, the system manager is launched in 820. In 825 and 830, the system manager launches the game manger and other pattern analysis engine components such as, for example, the pattern comparator. Once components of the pattern analysis engine have been launched, the pattern analysis procedure may continually run in the background preferably as a task in a “multi-tasking system.” Alternatively, the pattern analysis procedure may be triggered to run upon the occurrence of one or more predetermined events.

As another advantage, the pattern analysis techniques of the present invention may also be used to identify known or suspected invalid patterns, and to ensure that “rogue” programs are not operating on the gaming machine. For instance, one method which may be used to tamper with a gaming machine might be to introduce a rogue information onto the gaming machine and/or it's associated peripheral components. For example, rogue code may be used to trigger illegal jackpots on a gaming machine; pay table data may be illegally altered to increase game payouts; operating code for the bill validator may be illegally altered to accept counterfeit bills; etc.

As described in greater detail below, the technique of the present invention may be used: (1) to verify selected patterns of files, images, data, code, or other information; and/or (2) to identify unauthorized or anomalous patterns of files, images, data, code, or other information associated with the gaming machine and/or its peripheral components. The technique of the present invention may also be applied to verify any data structures or other information loaded into RAM from mass storage devices used in the presentation of a game on a gaming machine or in any other gaming service provided by the gaming machine. In this way the technique of the present invention may be implemented as an additional security measure to help reduce the risk of unauthorized tampering of a the gaming machine.

FIG. 8 shows a flow diagram of a Pattern Analysis Procedure 850 in accordance with a specific embodiment of the present invention. In at least one implementation, the Pattern Analysis Procedure 850 may be implemented at gaming machine 200 (FIG. 2) using hardware, software, or a combination thereof. In at least one embodiment, the Pattern Analysis Procedure 850 may be used for analyzing selected patterns of data relating to files, images, code, data, or other information in order, for example, to validate the authenticity of such patterns and/or to detect any anomalies.

In at least one implementation, the Pattern Analysis Procedure may be implemented by the master game controller 212 of FIG. 2. According to specific embodiments, a variety of different events may be used to trigger execution of the Pattern Analysis Engine or its related processes as described, for example, in FIGS. 4-9. For example, one event may correspond to the gaming machine door being opened or closed. A second event may be the initialization cycle of the gaming machine. A third event may correspond to a jackpot payoff. A fourth event that may trigger the pattern analysis procedure is the completion of downloading of remote game code data or other information from a remote server onto the gaming machine memory. Examples of other events include: scheduled and/or random testing events; execution of an executable pattern; monetary transfer to/from the gaming machine; attendant request via a gaming machine menu page; server request via a communication protocol; tale-tell board indication of monitored gaming machine hardware; received signals and/or other input from an external entity (e.g., remote server, casino attendant, etc.); player input; etc. In at least one embodiment, the detection of one or more specified events may cause the Pattern Analysis Procedure to automatically execute for analyzing selected patterns.

During execution of the Pattern Analysis Procedure, one or more patterns of file data, image data, code, and/or other information may be analyzed. Initially, as shown at 852, a first pattern is selected for analysis. According to different embodiments, the selected pattern may correspond to one or more of the following: a portion of a file or image; software code; operating code; gaming paytable data; audio data; machine op-code patterns (e.g., device access commands, memory access commands, bus access commands, etc); and/or other information relating to gaming machine operations.

The selected pattern may be retrieved or acquired from a variety of different sources such as, for example: processes residing within the gaming machine's volatile memory (e.g., RAM 209); files, images, data, code and/or other information residing in memory 216 of the gaming machine; files, images, data, code and/or other information residing in any of the peripheral devices 222; operating system code or instructions; files, images, data, code and/or other information provided from an external device such as, for example, a remote gaming server; hash codes, checksums and/or other coded information relating to one or more files, images, data, code and/or other information; information residing on portable memory devices such as CDs, DVDs, flash drives, etc; BIOS information, boot loader information; and/or any combination thereof.

After a desired pattern has been selected for analysis, pattern ID information relating to the selected pattern may be acquired (854). In at least one implementation, the pattern ID information may include information relating to various characteristics or parameters of the selected patterns such as, for example: pointer locations; pattern names or other identifier information; the name or identity of the device or source from which the pattern was acquired; code or other information which relates to an operation or function associated with a particular machine component (such as, for example, the IDE bus, PCI bus, PCI Express bus, ISA bus, USB, Firewire, BIOS, Northbridge, Southbridge, etc.); etc. For example, in one implementation where the pattern corresponds to a portion of a process residing in RAM, the pattern information may include pointers to location of the process in volatile memory (RAM), and the name of the process.

The pattern ID information may then be used (856) to retrieve pattern comparison information from one or more trusted entities. According to specific embodiments, the trusted entities and controlling circuitry may be designed to not allow modification of the code and data stored in the memory device while the memory device is installed in the gaming machine. The code and data stored in these devices may include authentication algorithms, random number generators, authentication keys, operating system kernels, etc. Information provided by the trusted entity may be provided or retrieved from an internal storage medium (internal to the gaming machine), from an external storage medium external to the gaming machine, and/or from an external source for remote source such as a gaming server or other type of server via a network.

One purpose of the trusted entities is to provide gaming regulatory authorities a root trusted authority within the computing environment of the gaming machine that can be tracked and verified as original. In at least one embodiment, at least a portion of the trusted entities/sources may correspond to memory which cannot easily be altered (e.g., “unalterable memory”) such as, for example, EPROMS, PROMS, Bios, Extended Bios, and/or other memory sources which are able to be configured, verified, and/or authenticated (e.g., for authenticity) in a secure and controlled manner. In one implementation, a trusted entity may include one or more remote hosts or servers. According to a specific implementation, when a trusted information source is in communication with a remote device via a network, the remote device may employ a verification scheme to verify the identity of the trusted information source. In at least one embodiment, the pattern authenticator may be configured as a software process which resides in a boot PROM of the gaming machine, which may be considered a trusted entity.

According to a specific embodiment, the pattern comparator 254 may be configured or designed to acquire the pattern ID information for the selected pattern, and provide the pattern ID information to the pattern authenticator 256 (which may be configured as a trusted entity). The pattern authenticator may then respond by providing information relating to one or more locations (e.g., on the hard drive) where portions of the comparison patterns (corresponding to the pattern ID information) can be found. The pattern authenticator (or trusted entity) may also be configured or designed to provide a portion of the comparison patterns to the pattern comparator. Thus, for example, in one implementation the pattern authenticator may return a list of file paths associated with a particular pattern name. The list may reference different memory locations, for example, if there are shared objects in the gaming machine system which reside in more than one location of the RAM and/or nonvolatile memory. If the pattern authenticator cannot find a match, then it may be determined that an error has been detected, and an appropriate error-handling process may be initiated. However, if the pattern authenticator identifies one or more memory locations (e.g., on the hard drive) corresponding to the selected pattern, then the selected pattern (e.g., from the RAM) may be matched against the appropriate comparison patterns (which, for example, have already been authenticated) in nonvolatile memory that have been identified by the pattern authenticator. According to a specific implementation, before any data or code is able to be stored on the hard drive of the gaming machine, it must first be authenticated using a specified public/private key and and/or other security certificate.

In at least one implementation, the pattern comparison information may include: (i) one or more valid, authenticated patterns associated with the pattern ID information; and/or (ii) one or more patterns (associated with the pattern ID information) which are known or suspected to be invalid/unauthorized.

Because each type of system operation can be mapped to a set of addresses for a particular operating system, it is possible to generate specific types of comparison patterns for specific operations using information relating to the interface addresses for such operations. Examples of invalid or suspect patterns may include unauthorized or unnecessary commands relating to, for example: device access actions; device driver access actions; hardware access actions; memory access actions; bus access actions; reprogrammable device program/erase actions, peripheral device access actions; known machine op-code patterns (e.g., device access commands, memory access commands, bus access commands, etc); etc. For example, if the pattern being analyzed relates to code for a USB driver, the USB driver may be permitted to access the USB bus, but may not be permitted to access the serial or parallel buses. Thus, if the USB driver code includes commands for accessing the serial bus, such commands may be identified as being invalid or suspect or otherwise anomalous. Other examples of invalid or suspect patterns include, for example: viruses; rogue code or data; corrupted code or data; known software virus patterns; known software worm patterns; known unauthorized machine op-code patterns; etc.

According to a specific embodiment, a pattern selected for analysis may be deemed to be invalid if the selected pattern cannot be found on the local hard drive of the gaming machine or, alternatively cannot be found at a trusted entity or a location specified by the trusted entity for retrieving comparison patterns. In at least one embodiment, the technique of the present invention may also be used to detect TSR (terminate and stay resident) anomalies in which invalid information is residing in volatile memory, but has no corresponding location on the disk or other nonvolatile memory.

According to a specific embodiment, the pattern authenticator or other trusted entity may acquire information relating to the identified pattern from a variety of sources. For example, the information that is provided by the pattern authenticator or trusted entity (e.g., location of pattern portions in memory, verified portions of the identified pattern, unauthorized patterns relating to or associated with the identified pattern, and/or other information relating to the identified pattern) may be retrieved from a variety of sources including, for example, memory 216, and/or one or more remote devices/servers via a network interface, etc. Additionally, pattern ID information relating to identify of the pattern may be retrieved from a remote source. For example, a pattern or portion thereof may be selected and provided to the Pattern Analysis Engine 250. The Pattern Analysis Engine may then analyze the pattern, extract and/or generate relevant information relating to the pattern, and provide the relevant information to an external entity (e.g., a remote server) in order to obtain the pattern name and/or other pattern ID information relating to the selected pattern.

Returning to FIG. 8, once the relevant pattern comparison information has been obtained, pattern analysis may then be performed (858) on the selected pattern using the pattern comparison information. In at least one embodiment, the pattern comparator 254 may be configured or designed to perform the pattern analysis.

In at least one embodiment, the pattern analysis may be used to verify that patterns selected for analysis conform with or match comparison patterns provided by the pattern comparison information (which, for example, have been validated and/or authenticated). Additionally (or alternatively), the pattern analysis may be used to compare selected patterns against known or suspected invalid patterns in order to identify anomalous or invalid portions of the selected patterns. Each of these different pattern analysis techniques is described in greater detail, for example, with respect to FIG. 9 of the drawings.

After the pattern analysis or pattern comparison operations have been performed, a determination is made (860) as to whether any anomalies have been detected. For example, an anomaly may be detected if the pattern comparator is not able to verify that a selected pattern matches an authenticated comparison pattern. An anomaly may also be detected if the pattern comparator identifies a match between a selected pattern and a known invalid comparison pattern.

According to specific embodiments, if an anomaly is detected during the pattern analysis, one or more appropriate anomaly handling procedure(s) may be implemented (862) such as, for example: shutting down the gaming machine; notifying a human operator or remote server of the detected anomaly; halting all or partial executions of code at the gaming machine; performing a memory core dump in order, for example, to preserve the state of all processes of the gaming machine as of the time the anomaly was detected; capturing and/or recording patterns relating to identified anomalies; reformatting and reloading selected portions of the gaming machine memory; etc.

For example, according to a specific embodiment, if a particular pattern being analyzed is identified as being rogue, invalid or unauthorized, the identified pattern may be stored in a write-only memory location of non-volatile storage at the gaming machine. Once the image of the rogue pattern has been stored in memory, it may later be used or added to a database of rogue or invalid patterns which may then be downloaded to other gaming machines so that the Pattern Analysis Engines of those gaming machines may perform specific searches for the identified rogue pattern(s).

Another error handling technique may include halting execution of one or more software components of the gaming machine in order to preserve their state for subsequent analysis. For example, when an anomaly is detected, the gamine machine is not shut down, but rather code executing on the gaming machine (e.g., only the process that is identified as being invalid, or the entire system) may be halted from that point on.

After the appropriate anomaly handling procedure(s) have been implemented, or if no anomalies are detected for the specified pattern analysis, a determination may be made (864) as to whether additional pattern analysis is to be performed upon other selected patterns. If so, then a next pattern may be selected (852) for analysis, as described above.

FIG. 9 shows an example of a Pattern Comparison Procedure 900 and according us with a specific embodiment of the present invention. According to a specific embodiment, the Pattern Comparison Procedure 900 of FIG. 9 may be implemented by one or more components of the Pattern Analysis Engine such as, for example, pattern comparator 254. In at least one implementation, the Pattern Comparison Procedure 900 may be initiated when performing pattern analysis or pattern comparison operations as described, for example, at 858 of FIG. 8.

As illustrated in the embodiment of FIG. 9, the Pattern Comparison Procedure 900 may be configured or designed to perform different types of pattern comparisons such as, for example: valid pattern verification (902) and/or invalid pattern identification (920). In at least one embodiment, valid pattern verification may include verifying that patterns selected for analysis conform with or match comparison patterns provided by the pattern comparison information. Invalid pattern identification may include comparing selected patterns against known or suspected invalid patterns in order to identify anomalous or invalid portions of the selected patterns.

During valid pattern verification, a first/next valid comparison pattern may be selected (904) from the pattern comparison information (e.g., described previously in FIG. 8). In at least one implementation, the selected valid comparison pattern may correspond to a trusted pattern which has been validated and/or authenticated.

A comparison may then be performed (906) between the pattern selected for analysis (e.g., at 852 of FIG. 8) and the selected valid comparison pattern. In one embodiment, the pattern comparison operations may be performed by the pattern comparator 254. According to different embodiments, the valid comparison pattern may be compared to the entirety or one or more selected portions of the pattern selected for analysis.

According to specific embodiments, if an anomaly is detected (908) as a result of performing the pattern comparison, one or more appropriate anomaly handling procedure(s) may be implemented (910).

After the appropriate anomaly handling procedure(s) have been implemented, or if no anomalies were detected during the pattern comparison, a determination may be made (912) as to whether additional valid pattern comparisons are to be performed upon the selected pattern. If so, then a next valid comparison pattern may be selected (904) for comparison with the pattern selected for analysis.

During invalid pattern verification, a first/next invalid comparison pattern may be selected (922) from the pattern comparison information (e.g., described previously in FIG. 8). In at least one implementation, the selected invalid comparison pattern may correspond to a pattern which is known or suspected as being invalid with respect to the pattern selected for analysis (e.g., at 852 of FIG. 8).

A comparison may then be performed (924) between the pattern selected for analysis and the selected invalid comparison pattern. In one embodiment, the pattern comparison operations may be performed by the pattern comparator 254. According to different embodiments, the invalid comparison pattern may be compared to the entirety or one or more selected portions of the pattern selected for analysis.

According to specific embodiments, if a match is detected (926) as a result of performing the pattern comparison, one or more appropriate anomaly handling procedure(s) may be implemented (928).

After the appropriate anomaly handling procedure(s) have been implemented, or if no anomalies were detected during the pattern comparison, a determination may be made (930) as to whether additional invalid pattern comparisons are to be performed upon the selected pattern. If so, then a next invalid comparison pattern may be selected (922) for comparison with the pattern selected for analysis.

In addition to analyzing patterns residing in the primary memory of the gaming machine, the Pattern Analysis Engine may also analyze patterns of files, images, data, code, and/or other information residing in the memory of associated peripheral devices (e.g., 222), and/or patterns which are provided from other external sources or remote sources. For example, desired portions of data or code from selected peripheral devices 222 may be analyzed for validation purposes and/or may be analyzed in order to detect presence of anomalies in the patterns being analyzed. Such a feature may be particularly useful in environments or embodiments where the code executed by one or more peripheral devices was provided via a remote gaming server via a network connection. Thus, it will be appreciated that the technique of the present invention provides additional security features for gaming machine peripheral devices which, in turn, provide the benefit of preventing invalid or unauthorized code/data from being executed or utilized on peripheral devices.

For example, in one implementation a bill validator module of gaming machine 2 (FIG. 1) may receive at least a portion of operating code from a remote server. In order to verify that the received code is authentic and valid, the Pattern Analysis Engine may analyze at least a portion of the bill validator code before the bill validator is permitted to go online. In another example, data from the hopper pay table may be analyzed by the Pattern Analysis Engine in order to validate the data and ensure that it is correct.

It will be appreciated that the pattern analysis technique of the present invention may be used to analyze patterns retrieved directly from persistent memory or nonvolatile memory as well as volatile memory such as RAM. For example, in one implementation, the pattern analysis procedure may be used to analyze one or more selected patterns retrieved from the gaming machine disk drive and/or retrieved from a remote gaming server before that pattern is loaded into the gaming machine RAM.

Additionally, in at least one implementation, the pattern analysis technique of the present invention may be used to analyze patterns of data in selected portions of the gaming machine memory independent of any existing file systems or file structures. For example, in one implementation, the pattern analysis technique of the present invention may be used to analyze selected sectors of raw data stored in one or more locations of the gaming machine memory. In one embodiment, the memory locations to be analyzed may be randomly selected, and/or may be selected using predetermined criteria.

In addition to analyzing a raw data, the technique of the present invention may also be used for analyzing processed data relating to one or more files, images, data or other information associated with the gaming machine. For example, in one implementation, the pattern analysis technique of the present invention may be used to analyze one or more hash codes corresponding to one or more files/images stored in the gaming machine memory. In one embodiment, the gaming machine of the present invention may be configured or designed to generate the processed data (e.g., hash codes) using files, images, and/or other data stored in the gaming machine memory. The generated processed data may then be analyzed, for example, using a comparison pattern which also includes processed data. For example, one type of invalid comparison pattern may correspond to a hash code that was generated using executable code from a known rogue program. The Pattern Analysis Engine may use this invalid comparison pattern, for example, to perform invalid pattern identification when analyzing processed data relating to one or more files, images, raw data or other information associated with the gaming machine.

Gaming System

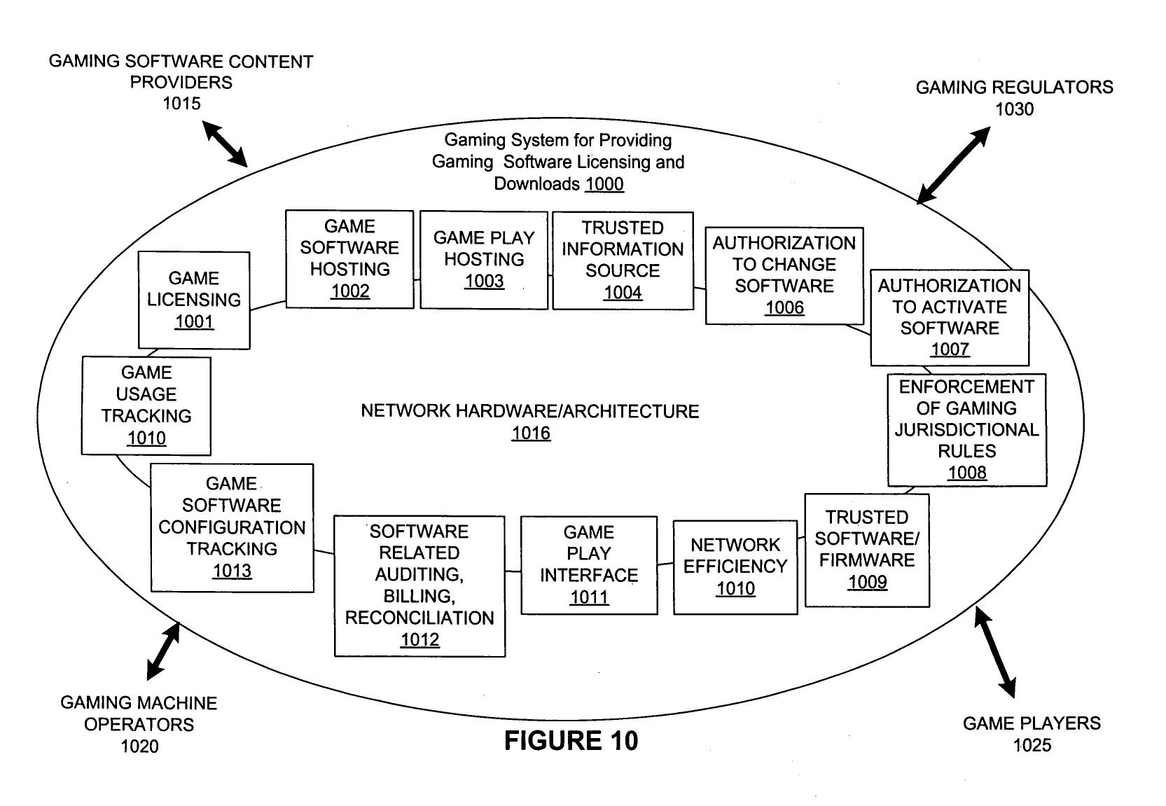

FIG. 10 shows a block diagram illustrating components of a gaming system 1000 which may be used for implementing various aspects of the present invention. In FIG. 10, the components of a gaming system 1000 for providing game software licensing and downloads are described functionally. The described functions may be instantiated in hardware, firmware and/or software and executed on a suitable device. In the system 1000, there may be many instances of the same function, such as multiple game play interfaces 1011. Nevertheless, in FIG. 10, only one instance of each function is shown. The functions of the components may be combined. For example, a single device may comprise the game play interface 1011 and include trusted memory devices or sources 1009.

The gaming system 1000 may receive inputs from different groups/entities and output various services and or information to these groups/entities. For example, game players 1025 primarily input cash or indicia of credit into the system, make game selections that trigger software downloads, and receive entertainment in exchange for their inputs. Game software content providers provide game software for the system and may receive compensation for the content they provide based on licensing agreements with the gaming machine operators. Gaming machine operators select game software for distribution, distribute the game software on the gaming devices in the system 1000, receive revenue for the use of their software and compensate the gaming machine operators. The gaming regulators 1030 may provide rules and regulations that must be applied to the gaming system and may receive reports and other information confirming that rules are being obeyed.

In the following paragraphs, details of each component and some of the interactions between the components are described with respect to FIG. 10. The game software license host 1001 may be a server connected to a number of remote gaming devices that provides licensing services to the remote gaming devices. For example, in other embodiments, the license host 1001 may 1) receive token requests for tokens used to activate software executed on the remote gaming devices, 2) send tokens to the remote gaming devices, 3) track token usage and 4) grant and/or renew software licenses for software executed on the remote gaming devices. The token usage may be used in utility based licensing schemes, such as a pay-per-use scheme.

In another embodiment, a game usage-tracking host 1015 may track the usage of game software on a plurality of devices in communication with the host. The game usage-tracking host 1015 may be in communication with a plurality of game play hosts and gaming machines. From the game play hosts and gaming machines, the game usage tracking host 1015 may receive updates of an amount that each game available for play on the devices has been played and on amount that has been wagered per game. This information may be stored in a database and used for billing according to methods described in a utility based licensing agreement.

The game software host 1002 may provide game software downloads, such as downloads of game software or game firmware, to various devious in the game system 1000. For example, when the software to generate the game is not available on the game play interface 1011, the game software host 1002 may download software to generate a selected game of chance played on the game play interface. Further, the game software host 1002 may download new game content to a plurality of gaming machines via a request from a gaming machine operator.

In one embodiment, the game software host 1002 may also be a game software configuration-tracking host 1013. The function of the game software configuration-tracking host is to keep records of software configurations and/or hardware configurations for a plurality of devices in communication with the host (e.g., denominations, number of paylines, paytables, max/min bets). Details of a game software host and a game software configuration host that may be used with the present invention are described in co-pending U.S. Pat. No. 6,645,077, by Rowe, entitled, “Gaming Terminal Data Repository and Information System,” filed Dec. 21, 2000, which is incorporated herein in its entirety and for all purposes.

A game play host device 1003 may be a host server connected to a plurality of remote clients that generates games of chance that are displayed on a plurality of remote game play interfaces 1011. For example, the game play host device 1003 may be a server that provides central determination for a bingo game play played on a plurality of connected game play interfaces 1011. As another example, the game play host device 1003 may generate games of chance, such as slot games or video card games, for display on a remote client. A game player using the remote client may be able to select from a number of games that are provided on the client by the host device 1003. The game play host device 1003 may receive game software management services, such as receiving downloads of new game software, from the game software host 1002 and may receive game software licensing services, such as the granting or renewing of software licenses for software executed on the device 1003, from the game license host 1001.

In particular embodiments, the game play interfaces or other gaming devices in the gaming system 1000 may be portable devices, such as electronic tokens, cell phones, smart cards, tablet PC's and PDA's. The portable devices may support wireless communications and thus, may be referred to as wireless mobile devices. The network hardware architecture 1016 may be enabled to support communications between wireless mobile devices and other gaming devices in gaming system. In one embodiment, the wireless mobile devices may be used to play games of chance.

The gaming system 1000 may use a number of trusted information sources. Trusted information sources 1004 may be devices, such as servers, that provide information used to authenticate/activate other pieces of information. CRC values used to authenticate software, license tokens used to allow the use of software or product activation codes used to activate to software are examples of trusted information that might be provided from a trusted information source 1004. Trusted information sources may be a memory device, such as an EPROM, that includes trusted information used to authenticate other information. For example, a game play interface 1011 may store a private encryption key in a trusted memory device that is used in a private key-public key encryption scheme to authenticate information from another gaming device.

When a trusted information source 1004 is in communication with a remote device via a network, the remote device will employ a verification scheme to verify the identity of the trusted information source. For example, the trusted information source and the remote device may exchange information using public and private encryption keys to verify each other's identities. In another embodiment of the present invention, the remote device and the trusted information source may engage in methods using zero knowledge proofs to authenticate each of their respective identities. Details of zero knowledge proofs that may be used with the present invention are described in US publication no. 2003/0203756, by Jackson, filed on Apr. 25, 2002 and entitled, “Authentication in a Secure Computerized Gaming System, which is incorporated herein in its entirety and for all purposes.

Gaming devices storing trusted information might utilize apparatus or methods to detect and prevent tampering. For instance, trusted information stored in a trusted memory device may be encrypted to prevent its misuse. In addition, the trusted memory device may be secured behind a locked door. Further, one or more sensors may be coupled to the memory device to detect tampering with the memory device and provide some record of the tampering. In yet another example, the memory device storing trusted information might be designed to detect tampering attempts and clear or erase itself when an attempt at tampering has been detected.

The gaming system 1000 of the present invention may include devices 1006 that provide authorization to download software from a first device to a second device and devices 1007 that provide activation codes or information that allow downloaded software to be activated. The devices, 1006 and 1007, may be remote servers and may also be trusted information sources. One example of a method of providing product activation codes that may be used with the present invention is describes in previously incorporated U.S. Pat. No. 6,264,561.

A device 1006 that monitors a plurality of gaming devices to determine adherence of the devices to gaming jurisdictional rules 1008 may be included in the system 1000. In one embodiment, a gaming jurisdictional rule server may scan software and the configurations of the software on a number of gaming devices in communication with the gaming rule server to determine whether the software on the gaming devices is valid for use in the gaming jurisdiction where the gaming device is located. For example, the gaming rule server may request a digital signature, such as CRC's, of particular software components and compare them with an approved digital signature value stored on the gaming jurisdictional rule server.

Further, the gaming jurisdictional rule server may scan the remote gaming device to determine whether the software is configured in a manner that is acceptable to the gaming jurisdiction where the gaming device is located. For example, a maximum bet limit may vary from jurisdiction to jurisdiction and the rule enforcement server may scan a gaming device to determine its current software configuration and its location and then compare the configuration on the gaming device with approved parameters for its location.

A gaming jurisdiction may include rules that describe how game software may be downloaded and licensed. The gaming jurisdictional rule server may scan download transaction records and licensing records on a gaming device to determine whether the download and licensing was carried out in a manner that is acceptable to the gaming jurisdiction in which the gaming device is located. In general, the game jurisdictional rule server may be utilized to confirm compliance to any gaming rules passed by a gaming jurisdiction when the information needed to determine rule compliance is remotely accessible to the server.

Game software, firmware or hardware residing a particular gaming device may also be used to check for compliance with local gaming jurisdictional rules. In one embodiment, when a gaming device is installed in a particular gaming jurisdiction, a software program including jurisdiction rule information may be downloaded to a secure memory location on a gaming machine or the jurisdiction rule information may be downloaded as data and utilized by a program on the gaming machine. The software program and/or jurisdiction rule information may used to check the gaming device software and software configurations for compliance with local gaming jurisdictional rules. In another embodiment, the software program for ensuring compliance and jurisdictional information may be installed in the gaming machine prior to its shipping, such as at the factory where the gaming machine is manufactured.

The gaming devices in game system 1000 may utilize trusted software and/or trusted firmware. Trusted firmware/software is trusted in the sense that is used with the assumption that it has not been tampered with. For instance, trusted software/firmware may be used to authenticate other game software or processes executing on a gaming device. As an example, trusted encryption programs and authentication programs may be stored on an EPROM on the gaming machine or encoded into a specialized encryption chip. As another example, trusted game software, i.e., game software approved for use on gaming devices by a local gaming jurisdiction may be required on gaming devices on the gaming machine.

In the present invention, the devices may be connected by a network 1016 with different types of hardware using different hardware architectures. Game software can be quite large and frequent downloads can place a significant burden on a network, which may slow information transfer speeds on the network. For game-on-demand services that require frequent downloads of game software in a network, efficient downloading is essential for the service to viable. Thus, in the present inventions, network efficient devices 1010 may be used to actively monitor and maintain network efficiency. For instance, software locators may be used to locate nearby locations of game software for peer-to-peer transfers of game software. In another example, network traffic may be monitored and downloads may be actively rerouted to maintain network efficiency.

One or more devices in the present invention may provide game software and game licensing related auditing, billing and reconciliation reports to server 1012. For example, a software licensing billing server may generate a bill for a gaming device operator based upon a usage of games over a time period on the gaming devices owned by the operator. In another example, a software auditing server may provide reports on game software downloads to various gaming devices in the gaming system 1000 and current configurations of the game software on these gaming devices.

At particular time intervals, the software auditing server 1012 may also request software configurations from a number of gaming devices in the gaming system. The server may then reconcile the software configuration on each gaming device. In one embodiment, the software auditing server 1012 may store a record of software configurations on each gaming device at particular times and a record of software download transactions that have occurred on the device. By applying each of the recorded game software download transactions since a selected time to the software configuration recorded at the selected time, a software configuration is obtained. The software auditing server may compare the software configuration derived from applying these transactions on a gaming device with a current software configuration obtained from the gaming device. After the comparison, the software-auditing server may generate a reconciliation report that confirms that the download transaction records are consistent with the current software configuration on the device. The report may also identify any inconsistencies. In another embodiment, both the gaming device and the software auditing server may store a record of the download transactions that have occurred on the gaming device and the software auditing server may reconcile these records.

There are many possible interactions between the components described with respect to FIG. 10. Many of the interactions are coupled. For example, methods used for game licensing may affect methods used for game downloading and vice versa. For the purposes of explanation, details of a few possible interactions between the components of the system 1000 relating to software licensing and software downloads have been described. The descriptions are selected to illustrate particular interactions in the game system 1000. These descriptions are provided for the purposes of explanation only and are not intended to limit the scope of the present invention.

Although several preferred embodiments of this invention have been described in detail herein with reference to the accompanying drawings, it is to be understood that the invention is not limited to these precise embodiments, and that various changes and modifications may be effected therein by one skilled in the art without departing from the scope of spirit of the invention as defined in the appended claims.

It is claimed:

1. A method of detecting at least one anomaly associated with gaming data, the gaming data being associated with a first gaming machine configured or designed to receive a wager on a game of chance, the method comprising:
selecting a first portion of gaming data for analysis, the first portion of gaming data corresponding to a first data pattern;
selecting a first comparison pattern relating to the first data pattern;
comparing the first comparison pattern to a first portion of the first data pattern; and
determining, based at least in part on the comparison of the first comparison pattern to the first portion of the first data pattern, whether at least one anomaly has been detected in association with the first data pattern.

2. The method of claim 1, wherein the game of chance is at least one of: a video slot game, a mechanical slot game, a lottery game, a video poker game, a video black jack game, a video card game, a video bingo game, a video keno game, and a video pachinko game.

3. The method of claim 1, wherein the first comparison pattern is certified for execution on the gaming machine in one or more gaming jurisdictions by a regulatory entity within each of the gaming jurisdictions.

4. The method of claim 1 further comprising:
processing selected portions of data stored in memory of the gaming machine to thereby generate the first portion of gaming data.

5. The method of claim 1 wherein the first portion of gaming data corresponds to raw data residing in at least one memory location of the gaming machine.

6. The method of claim 1 wherein the first comparison pattern corresponds to a valid comparison pattern, the method further comprising:
comparing the valid comparison pattern with the first portion of the first data pattern; and
identifying a first anomaly in response to a determination that the first portion of the first data pattern does not match the valid comparison pattern.

7. The method of claim 6 wherein the valid comparison pattern corresponds to a second portion of authenticated gaming data.

8. The method of claim 1 wherein the first comparison pattern corresponds to an invalid comparison pattern, the method further comprising:
comparing the invalid comparison pattern with the first portion of the first data pattern; and
identifying a first anomaly in response to a determination that the first portion of the first data pattern matches the invalid comparison pattern.

9. The method of claim 8 wherein the invalid comparison pattern corresponds to data which is known or suspected to be invalid.

10. The method of claim 1 further comprising:
initiating a first anomaly handling procedure in response to a determination that a first anomaly has been detected in association with the first data pattern.

11. The method of claim 1 further comprising:
initiating a first anomaly handling procedure in response to a determination that a first anomaly has been detected in association with the first data pattern;
wherein the first anomaly handling procedure includes preserving states of selected processes of the gaming machine.

12. The method of claim 1 further comprising:
initiating a first anomaly handling procedure in response to a determination that a first anomaly has been detected in association with the first data pattern;
wherein the first anomaly handling procedure includes halting execution of selected processes of the gaming machine.

13. The method of claim 1 further comprising:
initiating a first anomaly handling procedure in response to a determination that a first anomaly has been detected in association with the first data pattern;
wherein the first anomaly handling procedure includes:
storing information relating the first anomaly and associated first data pattern.

14. The method of claim 1 wherein the first portion of gaming data corresponds to executable code to be implemented at the gaming machine

15. The method of claim 1 wherein the first portion of gaming data corresponds to executable code to be implemented at a peripheral device associated with the gaming machine

16. The method of claim 1 wherein the first portion of gaming data corresponds to non-executable data for use by at least one gaming machine component.

17. The method of claim 1 further comprising:
detecting a first anomaly associated with the first data pattern;
wherein the first anomaly relates to detection of a virus associated with the first data pattern.

18. The method of claim 1 further comprising:
detecting a first anomaly associated with the first data pattern;
wherein the first anomaly relates to detection of rogue code associated with the first data pattern.

19. The method of claim 1 further comprising:
detecting a first anomaly associated with the first data pattern;
wherein the first anomaly relates to detection of corrupted data associated with the first data pattern.

20. The method of claim 1 further comprising:
detecting a first anomaly associated with the first data pattern;
wherein the first anomaly relates to detection of at least one unauthorized command associated with the first data pattern.

21. The method of claim 20 wherein the at least one unauthorized command relates to a device access operation.

22. The method of claim 20 wherein the at least one unauthorized command relates to a bus access operation.

23. The method of claim 20 wherein the at least one unauthorized command relates to a driver access operation.

24. The method of claim 20 wherein the at least one unauthorized command relates to a memory access operation.

25. The method of claim 1 further comprising:
acquiring pattern ID information relating to the first data pattern; and
retrieving the first comparison pattern using the pattern ID information.

26. The method of claim 25 further comprising:
providing at least a portion of the pattern ID information to a trusted entity; and
receiving pattern comparison information relating to the pattern ID information from the trusted entity;
wherein the pattern comparison information includes information relating to a first location for accessing the first comparison pattern.

27. The method of claim 1 wherein the first portion of game data corresponds to gaming data stored in the gaming machine RAM; and
wherein the comparison pattern corresponds to gaming data stored at a trusted memory source.

28. The method of claim 1 wherein the first portion of game data corresponds to gaming data stored in memory of the gaming machine; and
wherein the comparison pattern corresponds to gaming data stored at a local trusted memory source.

29. The method of claim 1 wherein the first portion of game data corresponds to gaming data stored in memory of the gaming machine; and
wherein the comparison pattern corresponds to gaming data stored at a remote trusted memory source.

30. The method of claim 1 wherein the first portion of game data corresponds to gaming data stored at a peripheral device associated with the gaming machine; and
wherein the comparison pattern corresponds to gaming data stored at a trusted memory source.

31. A gaming machine adapted to detect at least one anomaly associated with gaming data, the gaming machine being further adapted to receive a wager on a game of chance, the gaming machine comprising:
at least one processor;
at least one interface; and
memory;
the gaming machine being configured or designed to:
select a first portion of gaming data for analysis, the first portion of gaming data corresponding to a first data pattern;
select a first comparison pattern relating to the first data pattern;
compare the first comparison pattern to a first portion of the first data pattern; and
determine, based at least in part on the comparison of the first comparison pattern to the first portion of the first data pattern, whether at least one anomaly has been detected in association with the first data pattern.

32. The gaming machine of claim 31, wherein the game of chance is at least one of: a video slot game, a mechanical slot game, a lottery game, a video poker game, a video black jack game, a video card game, a video bingo game, a video keno game, and a video pachinko game.

33. The gaming machine of claim 31, wherein the first comparison pattern is certified for execution on the gaming machine in one or more gaming jurisdictions by a regulatory entity within each of the gaming jurisdictions.

34. The gaming machine of claim 31 being further configured or designed to:
process selected portions of data stored in the memory of the gaming machine to thereby generate the first portion of gaming data.

35. The gaming machine of claim 31 wherein the first portion of gaming data corresponds to raw data residing in at least one memory location of the memory.

36. The gaming machine of claim 31 wherein the first comparison pattern corresponds to a valid comparison pattern, the gaming machine being further configured or designed to:
compare the valid comparison pattern with the first portion of the first data pattern; and
identify a first anomaly in response to a determination that the first portion of the first data pattern does not match the valid comparison pattern.

37. The gaming machine of claim 36 wherein the valid comparison pattern corresponds to a second portion of authenticated gaming data.

38. The gaming machine of claim 31 wherein the first comparison pattern corresponds to an invalid comparison pattern, the gaming machine being further configured or designed to:
compare the invalid comparison pattern with the first portion of the first data pattern; and
identify a first anomaly in response to a determination that the first portion of the first data pattern matches the invalid comparison pattern.

39. The gaming machine of claim 38 wherein the invalid comparison pattern corresponds to data which is known or suspected to be invalid.

40. The gaming machine of claim 31 being further configured or designed to:
initiate a first anomaly handling procedure in response to a determination that a first anomaly has been detected in association with the first data pattern.

41. The gaming machine of claim 31 being further configured or designed to:
initiate a first anomaly handling procedure in response to a determination that a first anomaly has been detected in association with the first data pattern;
wherein the first anomaly handling procedure includes preserving states of selected processes of the gaming machine.

42. The gaming machine of claim 31 being further configured or designed to:
initiate a first anomaly handling procedure in response to a determination that a first anomaly has been detected in association with the first data pattern;
wherein the first anomaly handling procedure includes halting execution of selected processes of the gaming machine.

43. The gaming machine of claim 31 being further configured or designed to:
initiate a first anomaly handling procedure in response to a determination that a first anomaly has been detected in association with the first data pattern;
wherein the first anomaly handling procedure includes:
store information relating the first anomaly and associated first data pattern.

44. The gaming machine of claim 31 wherein the first portion of gaming data corresponds to executable code to be implemented at the gaming machine

45. The gaming machine of claim 31 wherein the first portion of gaming data corresponds to executable code to be implemented at a peripheral device associated with the gaming machine

46. The gaming machine of claim 31 wherein the first portion of gaming data corresponds to non-executable data for use by at least one gaming machine component.

47. The gaming machine of claim 31 being further configured or designed to:
detect a first anomaly associated with the first data pattern;
wherein the first anomaly relates to detection of a virus associated with the first data pattern.

48. The gaming machine of claim 31 being further configured or designed to:
detect a first anomaly associated with the first data pattern;
wherein the first anomaly relates to detection of rogue code associated with the first data pattern.

49. The gaming machine of claim 31 being further configured or designed to:
detect a first anomaly associated with the first data pattern;
wherein the first anomaly relates to detection of corrupted data associated with the first data pattern.

50. The gaming machine of claim 31 being further configured or designed to:
detect a first anomaly associated with the first data pattern;
wherein the first anomaly relates to detection of at least one unauthorized command associated with the first data pattern.

51. The gaming machine of claim 50 wherein the at least one unauthorized command relates to a device access operation.

52. The gaming machine of claim 50 wherein the at least one unauthorized command relates to a bus access operation.

53. The gaming machine of claim 50 wherein the at least one unauthorized command relates to a driver access operation.

54. The gaming machine of claim 50 wherein the at least one unauthorized command relates to a memory access operation.

55. The gaming machine of claim 31 being further configured or designed to:
acquire pattern ID information relating to the first data pattern; and
retrieve the first comparison pattern using the pattern ID information.

56. The gaming machine of claim 55 being further configured or designed to:
provide at least a portion of the pattern ID information to a trusted entity; and
receive pattern comparison information relating to the pattern ID information from the trusted entity;
wherein the pattern comparison information includes information relating to a first location for accessing the first comparison pattern.

57. The gaming machine of claim 31 wherein the first portion of game data corresponds to gaming data stored in the gaming machine RAM; and
wherein the comparison pattern corresponds to gaming data stored at a trusted memory source.

58. The gaming machine of claim 31 wherein the first portion of game data corresponds to gaming data stored in memory of the gaming machine; and
wherein the comparison pattern corresponds to gaming data stored at a local trusted memory source.

59. The gaming machine of claim 31 wherein the first portion of game data corresponds to gaming data stored in memory of the gaming machine; and
wherein the comparison pattern corresponds to gaming data stored at a remote trusted memory source.

60. The gaming machine of claim 31 wherein the first portion of game data corresponds to gaming data stored at a peripheral device associated with the gaming machine; and
wherein the comparison pattern corresponds to gaming data stored at a trusted memory source.

61. The gaming machine of claim 31 further comprising:
a pattern comparator configured or designed to perform at least a portion of the comparison of the first comparison pattern to the first portion of the first data pattern; and
a pattern authenticator configured or designed to provide information relating to a first location for accessing the first comparison pattern.
